(19) United States
(12) Patent Application Publication
(10) Pub. No.: US 2026/0042608 A1
(43) Pub. Date: Feb. 12, 2026

(54) APPARATUS AND METHOD FOR SCHEDULING SEQUENCED DELIVERY OF ITEMS IN A MULTILEVEL STORE FACILITY

(71) Applicant: Symbotic LLC, Wilmington, MA (US)

(72) Inventors: Alexander DOWNEY, Wilmington, MA (US); Rick Youping HUANG, Westford, MA (US)

(21) Appl. No.: 19/293,379

(22) Filed: Aug. 7, 2025

Related U.S. Application Data
(60) Provisional application No. 63/680,757, filed on Aug. 8, 2024.

(51) Int. Cl. B65G 1/137; B65G 1/06

(52) U.S. Cl. CPC B65G 1/1373; B65G 1/065

(57) ABSTRACT

A product order fulfillment system includes: a multi-level transport system, each level thereof having a corresponding independent asynchronous level transport system; a lifting transport system with more than one independent lift axis, in a common lift cell, each of the more than one independent lift axis being configured to independently hold and transport the at least one case along a trajectory; and a controller operably coupled to the multi-level transport system and the lifting transport system; where the asynchronous trajectories of the common lift cell output an ordered sequence of mixed cases in accordance to a predetermined case out ordered sequence of mixed cases; and where the controller is configured to heuristically generate optimal trajectory solutions for the asynchronous trajectories, and assign the at least one case to at least one asynchronous level transport axis based on at least one qualitative metric characterized by the optimal trajectory solutions.

### CROSS-REFERENCE TO RELATED APPLICATIONS

This application is a non-provisional of and claims the benefit of U.S. provisional patent application No. 63/680,757 filed on Aug. 8, 2024, the disclosure of which is incorporated herein by reference in its entirety.

### BACKGROUND

### 1. Field

The present disclosure generally relates to storage and retrieval systems, and more particularly, to sequencing of items in the storage and retrieval system.

### 2. Brief Description of Related Developments

In automated warehouses, items to be shipped to customers are often packed for shipping in a particular sequence of outbound items. The particular sequence of outbound items in which the items are packed may arise from the processes of palletization according to pre-computed pallet build patterns, predetermined areas in shipping trucks for different products to be distributed at different stops on truck routes, and/or customer specifications particular to a floorplan of a customer's retail store.

The predetermined sequences of outbound items are generally provided by various pieces of machinery working in parallel and simultaneously with one another. Items are generally delivered from storage locations to final positions on pallets or trucks through one or more intermediate stops. For example, an item may be transported on a storage level of the automated warehouse in a horizontal transfer (such as by mobile robots or shuttles) from a storage location to a location where another piece of automation can pick up the item for vertical transport. The item may be picked for vertical transfer (such as by a mini-load crane, reciprocating vertical lift, or vertical conveyor) from the storage level and transported vertically to a location on an outbound conveyor. The outbound conveyor transports the item to a truck, a palletizer, or individual fulfilment station.

The horizontal and vertical transport machinery of the automated warehouse operate in parallel and not strictly concurrently with one another. There may be certain time intervals between the end of the horizontal transfer of an item and a moment when the same item is picked by the vertical transport machinery. These time intervals may be different for different items and can range from zero to significant time spans (e.g., several minutes) where an item remains in a buffer position after horizontal transport waiting to be transported vertically. Final sequences of outbound items are products of intermediate sequences provided by the transport of items by horizontal and vertical automated machinery to intermediate locations. Some of the automated machinery operate independently of one another, while others operate jointly in succession and need to be timed with one another.

Accordingly, the present disclosure addresses a number of those issues.

### BRIEF DESCRIPTION OF THE DRAWINGS

The foregoing aspects and other features of the present disclosure are explained in the following description, taken in connection with the accompanying drawings, wherein:

FIG. 1 is a schematic illustration of a product order fulfillment system in accordance with the present disclosure;

FIGS. 2 and 2A are respectively schematic illustrations of portions of the product order fulfillment system of FIG. 1 in accordance with the present disclosure;

FIG. 3 is a schematic illustration of a portion of the product order fulfillment system of FIG. 1 in accordance with the present disclosure;

FIG. 4 is a schematic illustration of a portion of the product order fulfillment system of FIG. 1 in accordance with the present disclosure;

FIGS. 5A and 5B are a schematic illustrations of a portion of the product order fulfillment system of FIG. 1 in accordance with the present disclosure;

FIG. 6 is a graph of a penalty function applied to a portion of the product order fulfillment system of FIG. 1 in accordance with the present disclosure;

FIGS. 7A and 7B are exemplary illustrations of prioritizing tasks for a portion of the product order fulfillment system of FIG. 1 in accordance with the present disclosure;

FIG. 8 is a schematic diagram of communications between components of the product order fulfillment system of FIG. 1 in accordance with the present disclosure;

FIG. 9 is a schematic diagram of communications between components of the product order fulfillment system of FIG. 1 in accordance with the present disclosure;

FIG. 10 is an exemplary flow diagram for a process flow of transferring cases in the product order fulfillment system of FIG. 1 in accordance with the present disclosure;

FIGS. 11A and 11B collectively referred to as FIG. 11 is an exemplary flow diagram of a method in accordance with the present disclosure;

FIGS. 12A1 and 12A2 collectively referred to as FIG. 12A, and FIGS. 12B1 and 12B2 are collectively referred to as FIG. 12B are an exemplary flow diagram of a method in accordance with the present disclosure;

FIG. 13 is an exemplary flow diagram of a method in accordance with the present disclosure;

FIG. 14 is an exemplary flow diagram of a method in accordance with the present disclosure; and

FIG. 15 is an exemplary flow diagram of a method in accordance with the present disclosure.

### DETAILED DESCRIPTION

The following detailed description is meant to assist the understanding of one skilled in the art, and is not intended in any way to unduly limit claims connected or related to the present disclosure.

The following detailed description references various figures, where like reference numbers refer to like components and features across various figures, whether specific figures are referenced, or not.

The word “each” as used herein refers to a single object (i.e., the object) in the case of a single object or each object in the case of multiple objects. The words “a,” “an,” and “the” as used herein are inclusive of “at least one” and “one or more” so as not to limit the object being referred to as being in its “singular” form.

The term “axis” or “axes” is used herein with respect to transport of cases with lifts 150 and autonomously guided vehicles 110, 262. The terms axis and axes are do not denote a “straight imaginary line about which a body rotates” or a “fixed reference line for the measurement of coordinates” but rather, as used herein the terms axis and axes are representationally/figuratively used to denote a stream/path of items respective portions of the automated storage and retrieval system by automation in the respective portion of the automated storage and retrieval system.

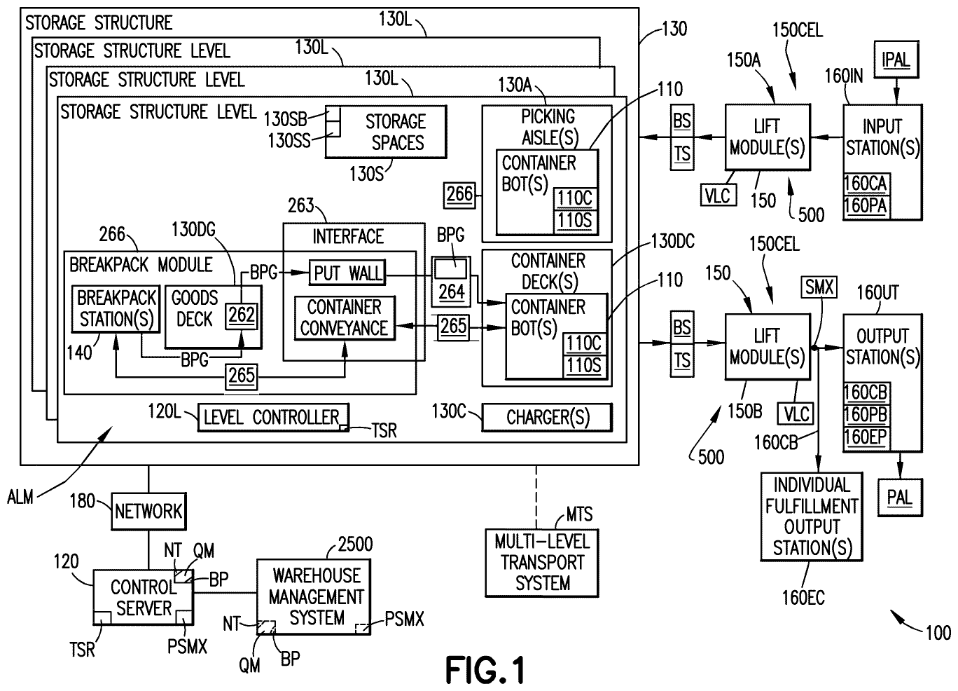

FIG. 1 illustrates an exemplary automated storage and retrieval system 100 (also referred to as a product order fulfillment system) in accordance with the present disclosure. Although the present disclosure will be described with reference to the drawings, it should be understood that the present disclosure can be embodied in many forms. In addition, any suitable size, shape or type of elements or materials could be used.

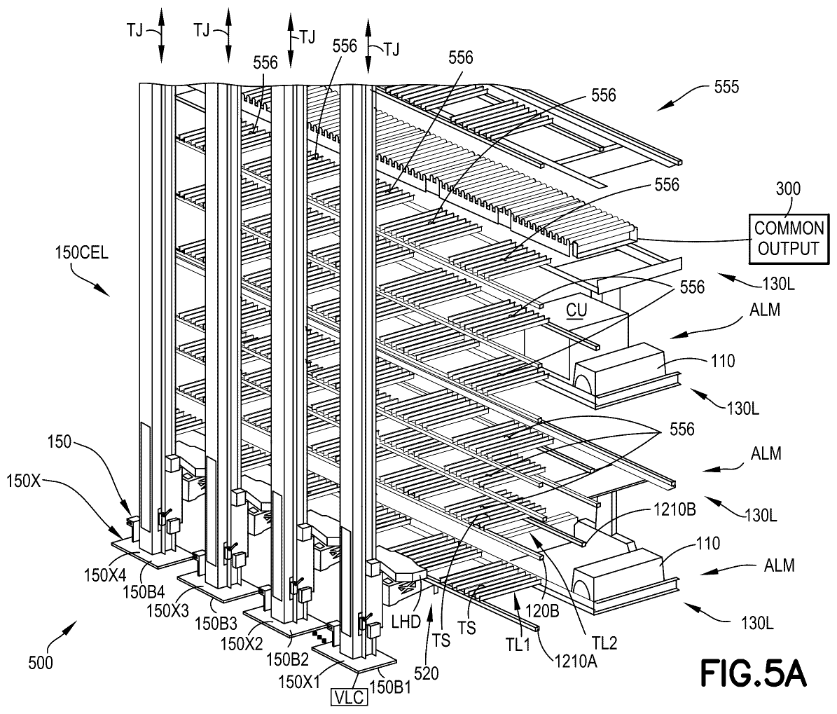

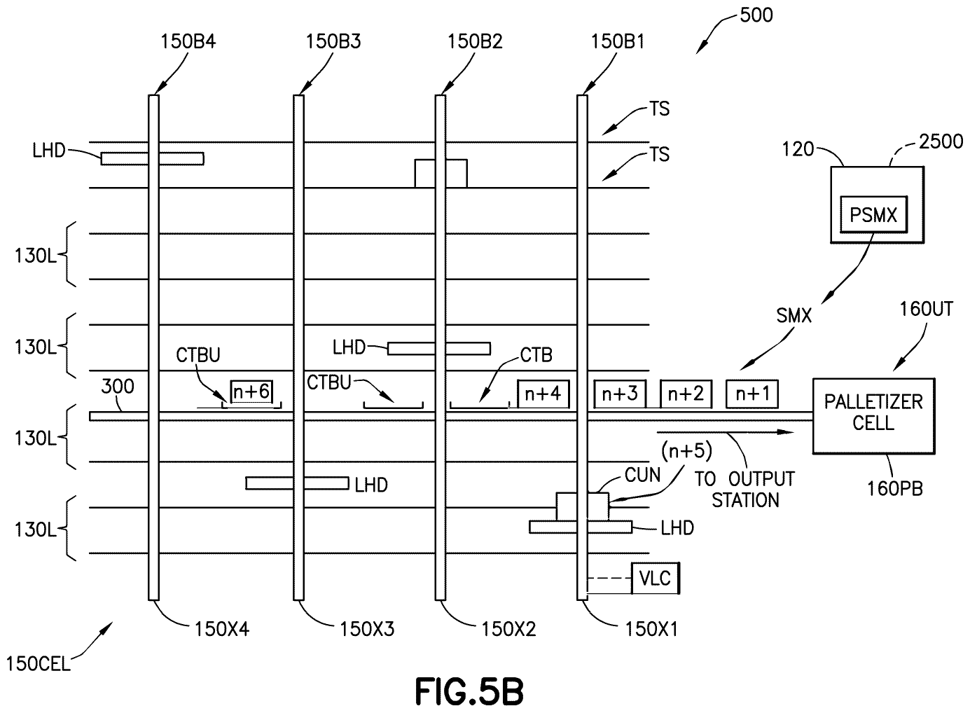

The present disclosure provides for one or more of: determining or otherwise computing the minimum time for transporting a case (e.g., of product/products, also referred to as a product unit) to an outbound conveyor 160CB, taking into account other cases that must precede a given case in a predetermined case out ordered sequence of mixed cases PSMX-see FIG. 5B) on the outbound conveyor 160CB; conflict resolution between tasks of more than one autonomously guided vehicle 110 where such conflict resolution considers the minimum time for transporting a case to an outbound conveyor 160CB; and lift 150 transfer efficiency considering the minimum time for transporting a case to an outbound conveyor 160CB. The minimum time for transporting a case to an outbound conveyor 160CB may be referred to, for explanation purposes only, as the “need time” Tn for a given case, which is the latest time the given case can arrive at a designated lift 150 transfer station TS (also referred to as a transfer buffer) from a storage location or space 130S by an autonomously guided transport vehicle 110 (or other device) for proper placement in an ordered sequence of mixed cases SMX, according to the predetermined case our ordered sequence of mixed cases PSMX, on the outbound conveyor 160CB.

In accordance with the present disclosure the product order fulfillment system 100 may operate in a retail distribution center or warehouse to, for example, fulfill product orders received from retail stores for items such as those described in U.S. Pat. No. 10,822,168 issued on Nov. 3, 2020, the disclosure of which is incorporated by reference herein in its entirety (the items are also referred to as cases, which include but are not limited to the supply containers 265 and breakpack goods containers 264 described herein). For example, the products may be in cases or units of goods not stored in trays, on totes or on pallets (e.g. uncontained). In other examples, the products are cases or units of goods that are contained in any suitable manner such as in trays, on totes, in containers (such as containers of remainder goods after breakpack where the broken down case unit structure is unsuitable for transport of the remainder goods as a unit) or on pallets. In still other examples, the products are a combination of uncontained and contained items. It is noted that the products, for example, include cased units of goods (e.g. case of soup cans, boxes of cereal, etc.) or individual goods that are adapted to be taken off or placed on a pallet. Shipping cases for the products (e.g. cartons, barrels, boxes, crates, jugs, or any other suitable device for holding products) may have variable sizes and may be used to hold products in shipping, and may be configured so they are capable of being palletized for shipping. It is noted that when, for example, bundles or pallets of cases arrive at the storage and retrieval system the content of each pallet may be uniform (e.g. each pallet holds a predetermined number of the same item-one pallet holds soup and another pallet holds cereal) and as pallets leave the storage and retrieval system the pallets may contain any suitable number and combination of different case units (e.g. a mixed pallet where each mixed pallet holds different types of case units-a pallet holds a combination of soup and cereal) that are provided to, for example the palletizer in a sorted arrangement for forming the mixed pallet. The storage and retrieval system 100 described herein may be applied to any environment in which case units are stored and retrieved.

In accordance with the present disclosure, orders for filled cases (e.g., the pallets, containers, package of goods, individual (unpacked) goods, etc.) may be stochastic (e.g., substantially random in the products ordered and a time the order is received) and may be fulfilled by the product order fulfillment system 100 as function of time (e.g., sortation of ordered goods at a predetermined scheduled time in advance of a time the order is to ship/be fulfilled or in a sortation of goods in a just-in-time manner). These stochastic orders are determinative of a pick sequence of sorted product units, such as for building a pallet load or pallet PAL (see, e.g., U.S. Pat. No. 8,965,559 titled “Pallet Building System” and issued on Feb. 24, 2015, and United States pre-grant publication number 2024/0051768 titled “Vertical Sequencer for Product Order Fulfillment” and published on Feb. 15, 2024, the disclosures of which are incorporated herein by reference in its entirety). The pallet PAL may include mixed cases, mixed totes, mixed packs, mixed units (or caches) per tote, etc. (collectively referred to as mixed cases). The sorted product units are picked from a common storage array (e.g., a storage array formed by storage spaces 130S of storage structure 130). The automated storage and retrieval system 100 effects a maximum throughput of goods for each order (e.g., received for processing by the automated storage and retrieval system 100) by employing or otherwise processing the order through one or more orthogonal (e.g., substantially independent) sortation echelons (such as described in, for example, U.S. patent application Ser. No. 17/358,383 filed on Jun. 25, 2021 and titled “Warehousing System for Storing and Retrieving Goods in Containers,” the disclosure of which is incorporated herein by reference in its entirety) to a sortation level needed (e.g., e.g., a controller 120 drills/drives down through the orthogonal sortation echelons to effect the desired level of sortation needed for a given order-a case level sortation, a pack level sortation, a unit/each level sortation or a combination thereof) to effect a given order from the common storage array independent of order type (e.g., a pallet order, a case order, a pack order, mixed orders, etc.), independent of order sequence, and independent of order time.

The product order fulfillment system 100 may include one or more breakpack modules 266. Exemplary breakpack modules 266 suitable for employment with the present disclosure include those described in Patent Cooperation Treaty application number PCT/US24/19932 filed on Mar. 14, 2024 and titled “Warehousing System for Storing and Retrieving Goods in Containers” with attorney docket number 1127P015998-WO (EQV) and U.S. patent application Ser. No. 18/605,294 filed Mar. 14, 2024 and titled “Warehousing System for Storing and Retrieving Goods in Containers” with attorney docket number 1127P016004-US (PAR), and those described in U.S. patent application Ser. No. 17/358,383 filed Jun. 25, 2021, Ser. No. 17/657,705 filed Apr. 1, 2022, and Ser. No. 18/323,758 filed May 25, 2023, the disclosures of which are incorporated herein by reference in their entireties. The breakpack module(s) 266 is/are configured to break down product or supply containers 265 into breakpack goods containers 264 for order fulfillment. Product is placed into the breakpack goods containers 264 with automation (such as a goods bot 262) such that the products are loosely placed. At least the breakpack goods containers 264 are automatically stacked on pallets PAL, as described herein, for shipping from the automated storage and retrieval system 100.

The automated storage and retrieval system 100 may include (in addition to or in lieu of the breakpack modules 266) one or more each pick modules substantially similar to those described in U.S. Pat. No. 9,037,286 issued on May 19, 2015 (the disclosure of which is incorporated herein by reference), where the breakpack goods containers 264 are filled by human or robotic operators and output for transport by at least one autonomous container transport vehicle 110 (also referred to herein as “container bots” or “autonomous guided vehicles” and which form at least a part of an asynchronous transport system for level transport as described herein) for placement in storage or for transfer to an output station 160UT.

A controller 120 (and/or warehouse management system 2500) of the product order fulfillment system 100 is operably coupled (such as through any suitable network 180) to a multilevel transport system MTS and a lifting transport system 500 of the product order fulfillment system 100. The controller 120 (and/or warehouse management system 2500) of the automated storage and retrieval system 100 is configured to effect operation of the product order fulfillment system 100 as described herein. For example, the controller 120 (and/or warehouse management system 2500) is operably coupled to (such as through any suitable network 180) and configured to effect operation of at least one container bot 110 and at least one goods bot 262 (one or more of which may form at least a part of the multi-level transport system MTS as described herein) for assembling orders of breakpack goods BPG from supply containers 265 into breakpack goods containers 264 and outfeed of breakpack goods containers 264 through container output/transfer stations TS. For example, the controller 120 may be configured to effect, through any suitable network 180 and in accordance with warehouse management system 2500 instruction, operation of the container bot(s) 110 between the container storage locations 130S, a breakpack operation station 140 (of a breakpack module 266), and a breakpack goods container 264 located at a goods interface 263 along a breakpack goods transfer deck 130DG. The goods interface 263 may include a container conveyance that transports supply containers 265 placed on the container conveyance by the container bot 110 to the breakpack operation station 140 where breakpack goods BPG are picked from the supply container 265 and placed into a breakpack goods container 264 by a human or automated operator. The controller 120 may be configured to effect operation of the goods bot(s) 262 so that transport of the breakpack goods BPG by the goods bot 262 traversing the goods transfer deck 130DG, sorts the breakpack goods BPG, e.g., in a unit/each level sortation, to corresponding breakpack goods containers 264. The controller 120 may be configured to effect operation of the container bot(s) 110 (e.g., traversing a container transfer deck 130DC) so that the container bot(s) 110 accesses corresponding breakpack goods containers 264 at the goods transfer deck 130DG, such as from a put wall where an array of breakpack goods containers 264 are disposed, and transports the breakpack goods containers 264 via traverse along the container transfer deck 130DC to at least one of a container output/transfer station TS, a buffer station BS, and/or a corresponding container storage location 130SB of the storage spaces 130S (formed by storage shelves 130SS) of a corresponding level 130L of a multilevel storage array (i.e., storage structure 130). The buffer stations BS may be disposed at any suitable location within a respective storage structure level 130L such as within a picking aisle 130A, along the container deck 130DC, and/or provided with or adjacent the container output/transfer station TS to facilitate container transfer between the container bot(s) 110 and lift modules 150A, 150B (one or more of the lift modules 150A, 150B may form a part of the lifting transport system 500 as described herein).

It is noted that when, for example, incoming bundles or pallets (also referred to as pallet loads) IPAL (e.g. from manufacturers or suppliers of case units) arrive at the storage and retrieval system 100 for replenishment of the automated storage and retrieval system 100, the content of each pallet IPAL may be uniform (e.g. each pallet holds a predetermined number of the same item-one pallet holds soup and another pallet holds cereal). The cases or containers of such pallet IPAL may be substantially similar or in other words, homogenous cases (e.g. similar dimensions), and may have the same SKU (otherwise, as noted before the pallets may be “rainbow” pallets having layers formed of homogeneous containers). As pallets PAL leave the storage and retrieval system 100, with containers, such as the breakpack goods containers 264, filling customer replenishment orders, the pallets PAL may contain any suitable number and combination of different containers (e.g., uncontained goods/case units, goods on trays, in totes, and/or in other suitable containers) and/or breakpack goods BPG (e.g., each pallet may hold different types of case units and/or breakpack goods in containers—a pallet holds a combination of canned soup, cereal, beverage packs, cosmetics and household cleaners).

The product order fulfillment system 100 may be configured to generally include an in-feed section, a storage and sortation section (where storage of items is optional), and an output section. The storage and retrieval system 100 operating for example as a retail distribution center may serve to receive uniform pallet loads IPAL of cases, breakdown the pallet goods or disassociate the cases (e.g., at input station 160IN) from the uniform pallet loads into independent case units or supply containers 265 handled individually by the system 100, retrieve and sort the different supply containers 265 sought by each order into corresponding groups, and transport and assemble the corresponding groups of supply containers 265 and/or breakpack goods BPG in breakpack goods containers 264 (e.g., at the output station 160UT) into what may be referred to as mixed case pallet loads (see pallet load PAL noted above). The system 100 operating, for example, as a retail distribution center may serve to receive uniform pallet loads IPAL of cases, breakdown the pallet goods or disassociate the cases from the uniform pallet loads (e.g., at the input station 160IN) into independent supply containers 265 handled individually by the system, retrieve and sort the different containers sought by each order into corresponding groups, and transport and sequence the corresponding groups of containers in the manner described in U.S. Pat. No. 9,856,083 issued on Jan. 2, 2018, the disclosure of which is incorporated herein by reference in its entirety.

The storage and sortation section includes a multilevel automated storage system that has an automated multi-level transport system MTS that in turn receives or feeds individual supply containers 265 into the multilevel storage array for storage in a storage area (such as storage spaces 130S of the storage structure 130). The storage and sortation section also defines outbound transport of containers from the multilevel storage array such that desired case units are individually retrieved in accordance with commands generated in accordance to orders entered into a warehouse management system, such as warehouse management system 2500, for transport to the output section by the multi-level transport system MTS.

The multi-level transport system MTS has a corresponding independent asynchronous level transport system ALM, of mixed cases, on each level 130L of the storage structure 130, where each level 130L may be considered a level of the multi-level transport system MTS. The corresponding independent asynchronous level transport system ALM on each level 130L is separate and distinct from the asynchronous level transport system ALM corresponding to each other level 130L of the multi-level transport system MTS (noting each level 130L illustrated in FIG. 1 is substantially the same such that they include substantially the same features). As described herein, the asynchronous level transport system ALM, of each level 130L, defines an array of asynchronous level transport axes, corresponding to the level 130L. The asynchronous level transport system ALM, of each level 130L, is configured to hold and asynchronously transport at least one case providing transport of mixed cases along the array of asynchronous level transport axes.

The storage and sortation section may receive individual supply containers 265 and/or breakpack goods containers 264, sort the individual containers (utilizing, for example, container buffer stations BS and container output/transfer stations TS described herein), e.g., in a container level sortation, and transfer the individual containers to the output section in accordance to orders entered into the warehouse management system. The sorting and grouping of containers according to order (e.g. an order out sequence) may be performed in whole or in part by either the storage and retrieval section (e.g., the container bots 110 and/or goods bots 262) or the output section (e.g., at least the lifts 150), or both, the boundary between being one of convenience for the description and the sorting and grouping being capable of being performed any number of ways. The intended result is that the output section assembles the appropriate group of ordered cases, that may be different in SKU, dimensions, etc. into mixed case pallet loads in the manner described in, for example, U.S. Pat. No. 8,965,559 issued on Feb. 24, 2015 and titled “Pallet Building System,” the disclosure of which is incorporated herein by reference in its entirety.

In the present disclosure, the output section generates a pallet load PAL in what may be referred to as a structured architecture of mixed container stacks. The structured architecture of the pallet load described herein is representative however; the pallet load may have any other suitable configuration. For example, the structured architecture may be any suitable predetermined configuration such as a truck bay load or other suitable container or load container envelope holding a structural load.

Still referring to FIG. 1, the automated storage and retrieval system 100 includes a storage array (e.g., storage structure 130 with storage shelves 130SS forming or otherwise having storage spaces 130S) with at least one elevated storage level 130L (where more than one elevated storage levels forms storage racks of stacked storage levels). Mixed product units or cases are input and distributed in the storage array in supply containers 265 of product units of common kind per container (each container input to the system 100 holds a common kind of stock keeping unit (SKU)). For example, the automated storage and retrieval system 100 includes input stations 160IN (which include depalletizers 160PA and/or conveyors 160CA for transporting items (e.g., inbound supply containers 265) to lift modules (or lifts) 150A for entry into a storage level 130L of the storage structure 130).

The automated storage and retrieval system 100 includes the automated multi-level transport system MTS (e.g., bots 110, 262, breakpack stations, and other suitable level transports described herein). Each level of the multi-level transport system MTS has a corresponding independent asynchronous level transport system ALM (including at least the container bots 110), of mixed cases, that is separate and distinct from the independent asynchronous level transport system corresponding to each other level of the multi-level transport system MTS. For example, each storage level 130L includes the corresponding independent asynchronous level transport system AML for transporting cases on a given storage level 130L (e.g., level transport).

Each storage level 130L of the product order fulfillment system 100 includes undeterministic container bots 110, forming at least a part of the corresponding independent asynchronous level transport system ALM of the storage level 130L. The container bots 110 are configured to travel along one or more physical pathways of the product order fulfillment system 100 (e.g., such pathways being along one or more of the picking aisles 130A, extension portions or piers 130PR, goods transfer deck 130DG, and container transfer deck 130DC, which with transport of cases along such pathways, define or otherwise embody the asynchronous level transport axes) to provide the product order fulfillment system 100 with at least one level of asynchronous case transport. The container bots 110 may be any suitable independently operable autonomous transport vehicles that carry and transfer containers along X and Y (planar) throughput axes throughout the storage and retrieval system 100. The container bots 110 may be automated, independent (e.g. free riding) autonomous transport vehicles. Suitable examples of container bots can be found in, for exemplary purposes only, U.S. Pat. No. 10,822,168 issued on Nov. 3, 2020; U.S. Pat. No. 8,425,173 issued on Apr. 23, 2013; U.S. Pat. No. 9,561,905 issued on Feb. 7, 2017; U.S. Pat. No. 8,965,619 issued on Feb. 24, 2015; U.S. Pat. No. 8,696,010 issued on Apr. 15, 2014; U.S. Pat. No. 9,187,244 issued on Nov. 17, 2015; U.S. Pat. No. 11,078,017 issued on Aug. 3, 2021; U.S. Pat. No. 9,499,338 issued on Nov. 22, 2016; U.S. Pat. No. 10,894,663 issued on Jan. 19, 2021; and U.S. Pat. No. 9,850,079 issued on Dec. 26, 2017, the disclosures of which are incorporated by reference herein in their entireties. The container bots 110 may be configured to place containers, such as the above described retail merchandise, into picking stock in the one or more levels of the storage structure 130 and then selectively retrieve ordered containers.

At least another level of asynchronicity is provided such that, for example, container/product holding locations are greater than the number of bots transporting containers/products.

The automated storage and retrieval system 100 also includes input and output vertical lift modules 150A, 150B (generally referred to as lift modules 150—it is noted that while input and output lift modules are shown, a single lift module may be used to both input and remove case units from the storage structure). The lift modules 150 may form a lifting transport system 500 where the lifting transport system 500 includes more than one independent lift axis 150X1-150Xn (see, e.g., FIGS. 5A and 5B) in a common lift cell 150CEL. Each lift axis 150X1-150Xn is a lift 150B; although each lift axis 150X1-150Xn may be any suitable lifting device as described herein with respect to lifts 150. The independent lift axes 150X1-150Xn are coupled or uncoupled so as to form a common infeed interface 555 (with infeed stations that include or otherwise define the transfer stations TS) and couple the multi-level transport system MTS to the output stations(s) 160UT through the common output 300.

The more than one independent lift axis 150X1-150Xn may be a reciprocating axis. For example, each of the lift axes 150X1-150Xn is configured to independently hold at least one case and reciprocate along a vertical axis (i.e., the Z axis or lift travel axis) of the lift axis independently raising and lowering the at least one case (singly or in groups, or in pickfaces) to provide lifting transport of mixed cases between more than one level 130L of the multi-level transport system MTS. Each of the more than one independent lift axis 150X1-150Xn is configured to independently hold and transport at least one case along a trajectory TJ, independently of each other independent lift axis 150X1-150Xn, so that the trajectory TJ, of the at least one case on the respective lift axis 150X1-150Xn, is asynchronous from each other respective trajectory TJ of each other independent lift axis 150X1-150Xn of the common lift cell 150CEL effecting transport of mixed cases from the array of asynchronous level transport axes. The asynchronous trajectories TJ of the common lift cell 150CEL output the ordered sequence of mixed cases SMX in accordance to the predetermined case out ordered sequence of mixed cases PSMX.

Each independent lift axis 150X1-150Xn is defined by or is otherwise embodied by a lift module (or lift) 150A, 150B configured for transporting cases/product units between storage levels 130L (e.g., between level transport). Each lift 150A, 150B is communicably connected to the storage array (e.g., formed by the storage spaces 130S of the storage level(s) 130L) so as to automatically retrieve and output, from the storage array, product units distributed in the containers in a common part (e.g., the storage locations 130S of a respective storage level 130L) of the at least one elevated storage level 130L of the storage array. The output product units being one or more of mixed singulated product units, in mixed packed groups, and in mixed containers.

As an example, the automated storage and retrieval system 100 includes output stations 160UT, 160EC (which include palletizers 160PB, operator stations 160EP and/or conveyors 160CB for transporting items (e.g., outbound supply containers 265 and filled breakpack goods (order) containers 264) from, for example, lift modules 150B (noting lift modules 150A may be used for case output as noted above) for removal from storage (e.g., to a palletizer (for palletizer load) or to a truck (for truck load)). The output station 160EC may be an individual fulfillment (or e-commerce) output station where, for example, filled breakpack goods (order) containers 264 including single goods items and/or small bunches of goods are transported for fulfilling an individual fulfillment order (such as an order placed over the Internet by a consumer). The output station 160UT may be a commercial output station where large numbers of goods are generally provided on pallets for fulfilling orders from commercial entities (e.g., commercial stores, warehouse clubs, restaurants, etc.). The automated storage and retrieval system 100 may include both the commercial output station 160UT and the individual fulfillment output station 160EC although, the automated storage and retrieval system may include one or more of the commercial output station 160UT and the individual fulfillment output station 160EC.

The storage structure 130 (which may have at least one elevated storage level 130L as noted above and may form a multilevel storage array), and at least one container bot 110 which may be confined to a respective storage level of the storage structure 130 and are distinct from a transfer deck 130DC on which they travel. It is noted that the depalletizers 160PA may be configured to remove case units from pallets so that the input station 160IN can transport the items to the lift modules 150 for input into the storage structure 130. The palletizers 160PB may be configured to place items removed from the storage structure 130 on pallets PAL for shipping. As used herein the lift modules 150, storage structure 130 and container bots 110 may be collectively referred to herein as the multilevel automated storage system (e.g. storage and sorting section) noted above, which has an integral “on the fly sortation” (e.g. sortation of case units during transport of the case units) so that case unit sorting and throughput occurs substantially simultaneously without dedicated sorters as described in U.S. Pat. No. 9,856,083, previously incorporated herein by reference in its entirety.

The lifts 150 may be connected via transfer stations TS (also referred to herein as container infeed stations when the lift 150 is an inbound lift 150A or as container outfeed stations when the lift 150 is an outbound lift 150B) to the container transfer deck 130DC, and each lift is configured to lift one or both of supply containers 265 (empty or filled) and the breakpack goods containers 264 (empty or filled) into and out of the at least one elevated storage level 130L of the storage structure 130. Container storage locations (or spaces) 130S are arrayed peripherally along the container transfer deck 130DC and/or picking aisles 130A such as described in U.S. Pat. No. 9,856,083, previously incorporated by reference herein in its entirety and U.S. Pat. No. 10,822,168 issued on Nov. 3, 2020, the disclosure of which is incorporated herein by reference in its entirety.

The container transfer decks 130DC are substantially open and configured for the undeterministic (i.e., not physically constrained) traversal of container bots 110 along multiple travel lanes across and along the container transfer decks 130DC. As described in U.S. Pat. No. 10,556,743 issued on Feb. 11, 2020 and having application Ser. No. 15/671,591 (the disclosure of which is incorporated herein by reference in its entirety) the multiple travel lanes may be configured to provide multiple access paths or routes to each storage location 130S (e.g., pickface, case unit, container, or other items stored on the storage shelves) so that container bots 110 may reach each storage location using, for example, a secondary path if a primary path to the storage location is obstructed. The container transfer deck(s) 130DC at each storage level 130L communicate with each of the picking aisles 130A on the respective storage level 130L.

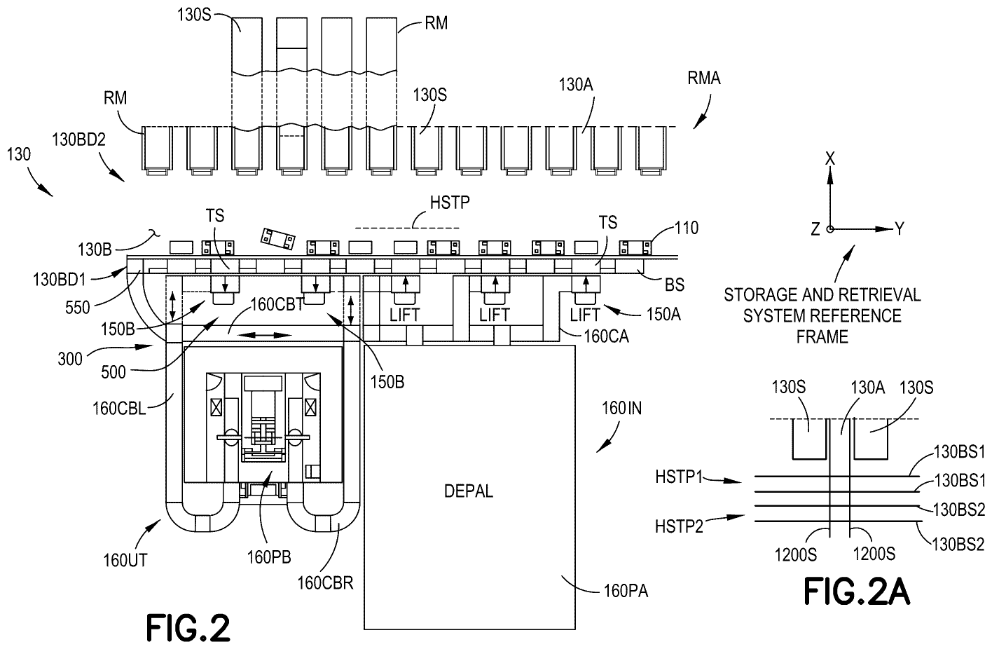

As described above, referring also to FIG. 2, the storage structure 130 includes multiple storage rack modules RM that are configured in a three dimensional array RMA, where the racks are arranged in aisles 130A and the aisles 130A are configured for container bot 110 travel within the aisles 130A. The transfer deck 130B has an undeterministic transport surface (substantially flat without physical guides guiding container bot 110 travel) on which the container bots 110 travel where the undeterministic transport surface 130BS has more than one juxtaposed travel lane (e.g. high speed bot travel paths HSTP) connecting the aisles 130A (although, each high speed bot travel path may be deterministic so as to provide physical constraints that guide container bot 110 travel). The juxtaposed travel lanes may be juxtaposed along a common undeterministic (or deterministic as shown in FIG. 2A) transport surface 130BS between opposing sides 130BD1, 130BD2 of the transfer deck 130B. Where the container deck 130B is deterministic, the container deck 130B may include any suitable number of guide features 130BS1, 130BS2, such as rails, guides, tracks, etc., which form one or more travel paths HSTP1, HSTP2 for the bots 110 and providing access to the lifts 150 (e.g., along the asynchronous level transport axes) across and along the container deck 130B. The deterministic travel paths HSTP1, HSTP2 of the container deck 130B may be arranged transverse to the picking aisles 130A of a respective level 130L. The container bots 110 may be suitably configured to transition between rails 1200S of the deterministic picking aisle 130A (e.g., along the asynchronous level transport axes) and a deterministic travel path HSTP1, HSTP2 in any suitable manner.

As illustrated in FIG. 2, the aisles 130A may be joined to the transfer deck 130B on one side 130BD2 of the transfer deck 130B, although the aisles are joined to more than one side 130BD1, 130BD2 of the transfer deck 130B in a manner substantially similar to that described in U.S. Pat. No. 10,822,168 issued on Nov. 3, 2020, the disclosure of which is incorporated by reference herein in its entirety. The other side 130BD1 of the transfer deck 130B may include deck storage racks (e.g. interface stations TS and buffer stations BS) that are distributed along the other side 130BD1 of the transfer deck 130B so that at least one part of the transfer deck is interposed between the deck storage racks (such as, for example, buffer stations BS or transfer stations TS) and the aisles 130A. The deck storage racks are arranged along the other side 130BD1 of the transfer deck 130B so that the deck storage racks communicate with the bots 110 from the transfer deck 130B and with the lift modules 150 (e.g. the deck storage racks are accessed by the bots 110 from the transfer deck 130B and by the lifts 150 for picking and placing pickfaces so that pickfaces are transferred between the bots 110 and the deck storage racks and between the deck storage racks and the lifts 150 and hence between the bots 110 and the lifts 150).

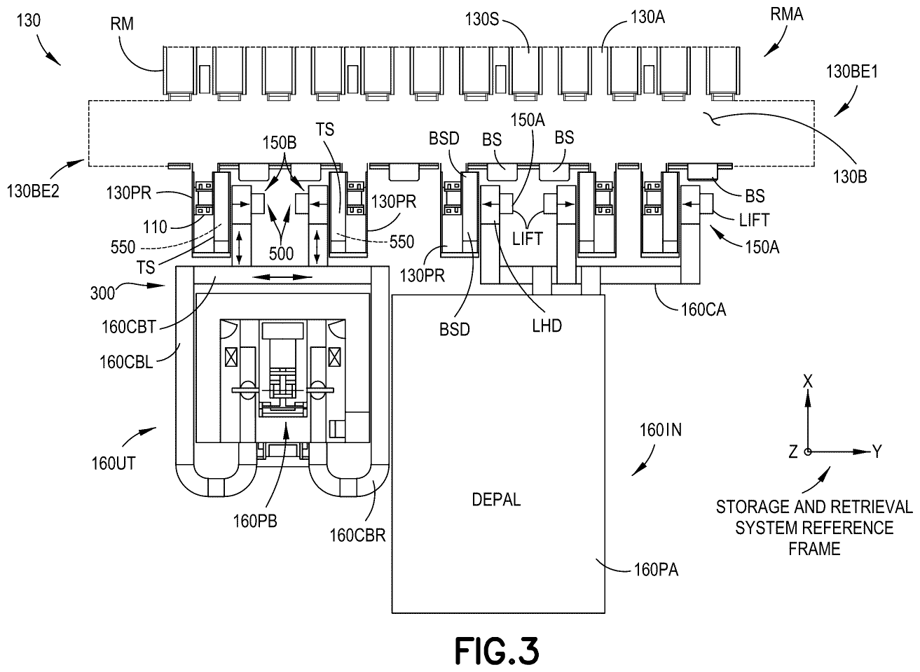

Referring also to FIG. 3, at least the interface stations TS may be located on an extension portion or pier 130PR that extends from the transfer deck 130B. The pier 130PR may be similar to the picking aisles 130A where the bot 110 travels along rails affixed to horizontal support members although, the travel surface of the pier 130PR may be substantially similar to that of the transfer deck 130B. Each pier 130PR is located at the side of the transfer deck 130B, such as a side that is opposite the picking aisles 130A and rack modules RM, so that the transfer deck 130B is interposed between the picking aisles and each pier 130PR. The pier(s) 130PR extends from the transfer deck at a non-zero angle relative to at least a portion of the high speed bot transport path HSTP although, the pier(s) 130PR may extend from any suitable portion of the transfer deck 130B including the ends 130BE1, 130BE2 of the transfer deck 130B. Peripheral buffer stations BSD (substantially similar to peripheral buffers stations BS described above) may be located at least along a portion of the pier 130PR.

As can be seen in FIG. 3, lifts 150 (outbound lift modules 150B and inbound lift modules 150A) are disposed adjacent respective piers 130PR in a manner similar to that described herein where the lifts 150 are disposed adjacent the transfer stations TS and buffer stations BS of the transfer deck 130B (see, e.g., FIGS. 2 and 5A). In FIG. 3, a single representative lift 150A, 150B is illustrated adjacent each pier 130PR; however, it should be understood that the single representative lift 150A, 150B may be representative of one or more lifts 150, such as of a lift cell 150CEL (see FIGS. 5A and 5B). In particular, one or more of the single representative outbound lifts 150B may be representative of the lifting transport system 500 including more than one lift 150B1-150B4 forming a lift cell 150CEL, where the lifts output items to a common output 300 such as the outbound conveyor 160CB.

The common output 300 may include one or more conveyor sections 160CBT, 160CBR, 160CBL (see FIGS. 2 and 3), where at least one of the conveyors sections is bidirectional. For example, conveyor section 160CBT may be bidirectional so as to transfer case units to either one of conveyors sections 160CBL, 160CBR (e.g., to either side of the palletizer 160PB) and/or to transfer case units between lifting and transport systems 500 connected to the conveyor section 160CBT to effect resequencing of case units such as described in United States pre-grant publication number 2024/0051768 published on Feb. 15, 2024, the disclosure of which is incorporated herein by reference in its entirety. There may be a plurality of lifting and transport sections 500 disposed on a common side of a common pier 130PR (e.g., one or more of the single representative outbound lifts 150B may be representative of a plurality of lifting and transport sections 500) in a manner substantially similar to that described above with respect to FIG. 2 where the plurality of lifting and transport sections 500 are disposed along the transfer deck 130B.

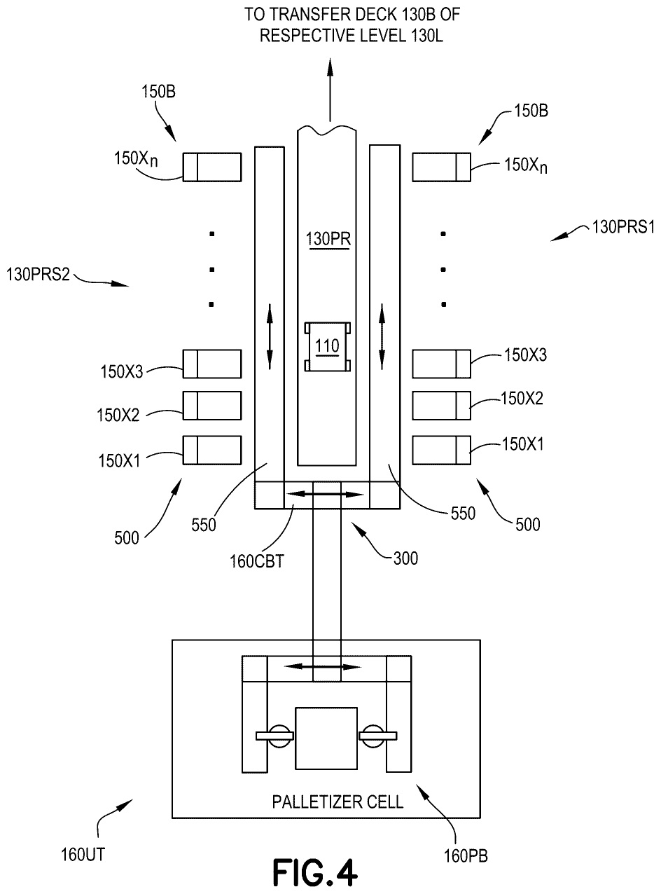

While FIG. 3 illustrates the lifting and transport systems 500 on a single side of a respective pier 130PR, in other aspects there may be a lifting and transport system 500 disposed on opposite sides of the pier 130PR as illustrated in FIG. 4. In FIG. 4, the common output 300 includes conveyor section 160CBT. The conveyor section 160CBT may be bidirectional so as to transport case units between the lifting and transport systems 500 disposed on the opposite sides of the pier 130PR. As may be realized, where case units are transferred between lifting and transport systems 500, the traverse 550 of the respective lifting and transport system 500 may be bidirectional so as to transport the case units to any one or more of the lift axes 150X1-150Xn of the respective lifting and transport system 500 for resequencing the case units as described herein.

Still referring again to FIG. 1, each storage level 130L may also include charging stations 130C for charging an on-board power supply of the container bots 110 on that storage level 130L such as described in, for example, U.S. patent application Ser. No. 14/209,086 filed on Mar. 13, 2014 and U.S. Pat. No. 9,082,112 issued on Jul. 14, 2015, the disclosures of which are incorporated herein by reference in their entireties.

As noted above, the automated storage and retrieval system 100 described herein generally delivers cases (a case being, e.g., a supply container 265, a breakpack goods container 264, or any other suitable container such as those described herein) retrieved from storage to outbound destinations for shipping in a specified (e.g., predetermined or precomputed) sequence (e.g., the predetermined case out ordered sequence of mixed cases PSMX). For example, cases may be transported horizontally within a single storage level 130L such as by autonomously guided transport vehicles 110 other devices (e.g., conveyors, goods bots 262, etc.) of a corresponding asynchronous level transport system ALM. This horizontal transport of cases may occur at one or more levels 130L of a multilevel storage structure 130, where cases are picked from storage on the one or more levels 130L, such as by the multi-level transport system MTS, and delivered to transfer stations TS on a respective storage level 130L. At the transfer stations TS, the cases wait to be picked by the one or more lifts 150, such as of a lift cell 150CEL. The cases are vertically transported by the one or more lifts 150, along a respective trajectory TJ, to positions on an outbound conveyor(s) 160CB, defining or otherwise embodying the common output 300, leading to various outbound destinations such as output stations 160UT and/or individual fulfillment output stations 160EC. The lifts 150 may produce the final sequencing of cases (e.g., the ordered sequence of mixed cases SMX in accordance to the predetermined case out ordered sequence of mixed cases PSMX) on the outbound conveyors 160CB, where the outbound conveyors 160CB transport the cases to a palletizer 160PB, at an output station 160UT, and/or to an individual fulfilment output station 160EC.

A single outbound destination may have the multiple independently operable lifts 150 (e.g., disposed in a lift cell 150CEL, see FIGS. 5A and 5B) that deliver the cases from the one or more storage levels 130L to the outbound conveyor 160CB leading to the outbound destination (see also FIGS. 5A and 5B). Depending on a sequence of lift 150 moves, it may take a variable time to outbound a certain number of cases in a specified time interval. For example, each independent lift axis 150X1-150Xn (and lift 150 embodying the independent lift axis), of the more than one lift axis 150X1-150Xn, is communicably coupled to each other independent lift axis lift axis 150X1-150Xn (and the respective lift embodying the other independent lift axis) of the more than one lift axis 150X1-150Xn of the common lift cell 150CEL and forms the common output 300 of the common lift cell 150CEL that outputs the ordered sequence of mixed cases SMX in accordance to the predetermined case out ordered sequence of mixed cases PSMX. The independent lift axes 150X1-150Xn may be disposed at different sequential locations along the outbound conveyor 160CB (see, e.g., FIGS. 4, 5A, and 5B).

Each lift 150 has access to respective transfer stations TS at every storage level 130L within a vertical column occupied by a respective lift 150 (see FIGS. 5A and 5B), where each lift 150 has a single projection area on the outbound conveyor 160CB (see FIG. 5A). Each lift 150 has a load handling device LHD that travels within the vertical column (e.g., along the trajectory TJ) and picks cases from the transfer stations TS and places the cases to the common output 300. Each storage level 130L has at least one transfer station TS in each vertical column occupied by a respective lift 150. Where more than one transfer station TS is provided on a storage level 130L the transfer stations may be disposed on one or more stacked level TL1, TL2 (see FIG. 5A), where the container bot 110 is configured to pick/place cases to the different stacked levels TL1, TL2 of the respective storage level 130L. The transfer stations TS may be defined at least in part by one or more rails 120A, 120B (see FIG. 5A).

For example, and for purposes of description (see, e.g., FIGS. 5A and 5B), what may be referred to as a first lift 150B1 has a position that is most downstream (e.g., closest to the output of the lift cell 150CEL relative to the flow of cases along the outbound conveyor and spatially compared to the other lifts in the lift cell) relative to the outbound conveyor 160CB. As such, where the first lift 150B1 and a second lift 150B2, that is upstream from the first lift 150B1, place cases at corresponding locations on the outbound conveyor 160CB, the two cases become adjacent one another (e.g., with respective sequence numbers n+1 and n+2) in the ordered sequence of mixed cases SMX and can be moved simultaneously towards the destination location, such as the output station 160UT or the individual fulfilment output station 160EC.

Where, for example a case that has sequence number n+1 is delivered to the outbound conveyor 160CB by the second lift 150B2, and a case with sequence number n+2 is delivered to the outbound conveyor 160CB by the first lift 150B1, the second lift 150B2 must place the case with sequence number n+1 on the outbound conveyor 160CB so that the outbound conveyor 160CB moves the case with sequence number n+1 towards the destination location past the first lift 150B1. Only after the case with sequence number n+1 passes the first lift 150B1 can the first lift 150B1 place the case with sequence number n+2 onto the outbound conveyor 150CB to maintain the final sequencing of cases on the outbound conveyor 160CB.

Where a lift cell 150CEL (see, e.g., FIGS. 5A and 5B) has more than one lift 150 the placement sequence of cases onto the outbound conveyor 160CB is to be performed in an orchestrated manner so as to effect the ordered sequence of mixed cases SMX in accordance to the predetermined case out ordered sequence of mixed cases PSMX. Some lift placement sequences may be more efficient than others in terms of the time intervals that separate placement of the different cases on the outbound conveyor 160CB by the lifts 150, where the time intervals are to be minimized. For example, where there are three lifts 150B1, 150B2, 150B3 (there may be more or fewer than three lifts-see, e.g., FIGS. 5A and 5B illustrating lifts 150B1-150B4, each having a respective lift column and defining a respective lift axis 150X1-150Xn that extends along the respective lift column) employed for transferring cases to the outbound conveyor 160CB in accordance with the ordered sequence of mixed cases SMX, some lift placement sequences may be more efficient than other lift placement sequences with respect to the time intervals that separate placement of the cases, by the lifts 150B1, 150B2, with sequence numbers n+1 and n+2. The most efficient lift sequence in the lift cell employing the three lifts 150B1, 150B2, 150B3 may be where case with sequence number n+1 is placed on the outbound conveyor 160CB by the first lift 150A, case with sequence number n+2 is placed on the outbound conveyor by the second lift 150B2, the case with sequence number n+3 is placed on the outbound conveyor 160CB by the third lift 150B3, case with sequence number n+4 is placed on the outbound conveyor by the first lift 150B1, and so on. A less efficient lift sequence may be where the third lift 150B3 places case with sequence number n+1 on the outbound conveyor 160CB, the second lift 150B2 places the case with sequence number n+2 on the outbound conveyor 160CB, the first lift 150B1 places the case with sequence number n+3 on the outbound conveyor, and so on. The least efficient lift sequence, assuming that the vertical transfer time by a lift 150 is longer than the transfer time on the outbound conveyor 160CB, may be where many cases in the ordered sequence of mixed cases SMX (e.g., with sequence numbers n+1, n+2, n+3, etc.) are on the same lift axis 150X1-150X3 (such as corresponding to and defined by a respective one of the lifts 150B1, 150B2, 150B3). In this least efficient lift sequence scenario, all other lifts 150 are paused while a single lift operates on the cases with sequence numbers n+1, n+2, n+3, etc. sequentially so that parallelism (or asynchronicity-independent operation of more than one lift to transfer items to the outbound conveyor 160CB) of the lifting transport system 500, provided by the more than one lift 150B1, 150B2, 150B3, is not utilized.

An unevenness in minimum time intervals between placement of cases next in sequence on the outbound conveyor 160CB leads to unevenness of the asynchronous pace of delivery of the cases to the transfer stations TS by the autonomously guided transport vehicles 110 (the transport autonomously guided vehicles 110, goods bots 262, and lifts 150 are asynchronous in that they each move independent of each other autonomously guided vehicle 110, goods bot 262, and lift 150 to effect case transport). The present disclosure provides for one or more of: the controller 120 (and/or warehouse management system 2500) being configured to heuristically generate (or otherwise determine) optimal (such as with respect to time) trajectory solutions for asynchronous trajectories TJ and assigning or tasking at least one case to at least one asynchronous level transport axis based on at least one qualitative metric (qualification) QM characterized by or described by the optimal trajectory solution(s); and the controller 120 (and/or warehouse management system 2500) being configured to heuristically generate (or otherwise determine) the optimal (such as with respect to time) trajectory solutions for the asynchronous trajectories TJ, and task the at least one case to at least one asynchronous level transport axis characterized with at least one qualitative metric (qualification) QM described by the optimal trajectory solution. The qualitative metric or qualification QM may be one or more of: the latest delivery times, also referred to as “need times” Tn, for at least one case at a predetermined destination of the asynchronous level transport system ALM of a corresponding level 130L, and a parametrized delay penalty metric (quantity) BP (also referred to as bot path priority) describing effects in asynchronous level transport from delays from a need time Tn. The predetermined destination may be a transfer station TS (or buffer shelf) communicably coupling the asynchronous level transport system ALM (e.g., on each level 130L) and a corresponding independent lift axis 150X1-150Xn of the more than one independent lift axis 150X1-150Xn.

Where the controller 120 (and/or warehouse management system 2500), effecting both task control and level 130L control, is configured to heuristically generate (or otherwise determine) optimal (such as with respect to time) trajectory solutions for asynchronous trajectories TJ and assigning or tasking at least one case to at least one asynchronous level transport axis based on at least one qualitative metric (qualification) QM characterized by or described by the optimal trajectory solution(s), at least the container bots 110 (and/or the goods bots 262) is assigned a task/case and a trajectory TS, all in one, by the controller 120 (and/or warehouse management system 2500) according to (or based on) the qualitative metric QM characterized by or described in the heuristic.

Where the controller 120 (and/or warehouse management system 2500) is configured to heuristically generate (or otherwise determine) the optimal (such as with respect to time) trajectory solutions for the asynchronous trajectories TJ, and task the at least one case to at least one asynchronous level transport axis characterized with at least one qualitative metric (qualification) QM described by the optimal trajectory solution, the controller 120 (and/or warehouse management system 2500) tasks a level 130L with the qualitative metric QM (i.e., a desired time of bot arrival/case transfer to a transfer station TS that is described as part of the heuristic that generates an optimal case trajectory TJ on a corresponding lift 150). A level controller 120L of a respective level 130L (which level 130 the controller 120 has tasked) is communicably connected to the controller 120 by a suitable network 180 and configured to assign, based on the qualitative metric QM, at least the container bot 110 and select the asynchronous transport axis/axes (along which at least the container bot 110 travels), such as with a bot path priority BP (as described herein); although the controller 120 effecting both tasking and level 130L control may be configured to effect bot path priority BP (as described herein).

The determined qualitative metric(s) QM are employed by, for example a control server 120 (and/or warehouse management system 2500) and/or the level controller 120L of the product order fulfillment system 100 for controlling movements of at least the container bots 110 that deliver the cases from inbound lifts 150A to storage locations 130S, and from the storage locations 130S to the outbound lifts 150B; although qualitative metrics QM may be equally applied to the goods bots 262 delivering breakpack goods BPG to the breakpack goods containers 265 at a put wall of the interface 263. The control server 120 (or warehouse management system 2500) and/or level controller 120L may employ a time-space reservation router TSR (or any other suitable router/algorithm) that is configured, in any suitable manner, to plan container bot 110 movement in large intervals, from one stop (e.g., to transfer cases at a storage location 130S, transfer station TS, or buffer station BS) in a rail line (e.g., picking aisles 130A and driveways/piers 130PR, both inbound and outbound, see FIGS. 2-4) to a next stop (e.g., to transfer cases at a storage location 130S, transfer station TS, or buffer station BS) in the same or another rail line (e.g., picking aisles 130A and driveways/piers 130PR, both inbound and outbound) substantially without stopping on a container deck 130DC of the product order fulfillment system 100; or from one stop in a rail line to a transfer station TS (or buffer station BS) along an edge of the a container deck 130DC without stopping at an intermediate location of the container deck 130DC. It is noted that container bots 110 travelling on the container deck 130DC may turn and maneuver around other autonomously guided transport vehicles 110 travelling on or stopped on the container deck 130DC.

Some (or all) of the picking aisles 130A and driveways/piers 130PR may be dead-end (only one way in/out) rail lines such that a conflict may arise between more than one autonomously guided transport vehicle 110 tasked to operate within the same picking aisle 130A or driveway/pier 130PR. The time-space reservation router TSR (e.g., of one or more of the controller 120, level controller 120L, and warehouse management system 2500) may be configured to resolve this conflict between the more than one autonomously guided transport vehicles 110. Where the need times Tn of predetermined outbound cases being transferred are not known, the conflict resolution may include a solution where the more than one container bots 110 access the picking aisle 130A or driveway/pier 130PR in the order in which they arrive at the picking aisle 130A or driveway/pier 130PR; however, where need times Tn are assigned to the predetermined outbound cases being transferred, the conflict resolution becomes based not only on proximity of each of the more than one container bot 110 to the picking aisle 130A or driveway/pier 130PR, but also on which container bot 110 is performing a transport task with the greatest urgency based on the need time Tn of the respective outbound cases being transferred. As described herein, the present disclosure may provide for conflict resolution (such as the bot priority BP) to, e.g., resolve the following situations: where two container bots 110 are assigned entry to the same storage aisle 130A to pick their corresponding cases and then travel to respective destination driveways/piers 130PR, and where two container bots 110 deliver cases to the same outbound driveway/pier 130PR from different storage aisles 130A, noting more complex situations may be handled by sequential application of the conflict resolution described herein), by applying, for example, the parametrized delay penalty metric (bot priority) BP to one or more of the conflicted container bots 110.

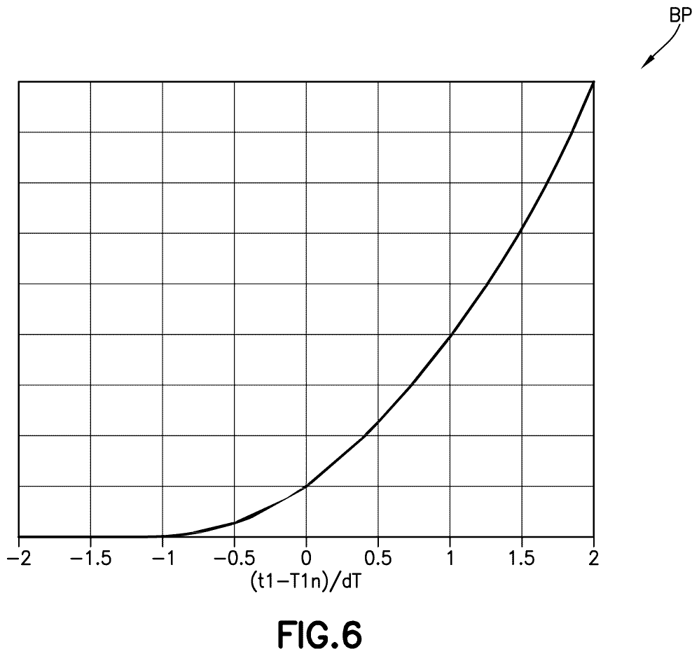

An example of a parametrized delay penalty metric (bot priority) BP is illustrated in FIG. 6. The parametrized delay penalty metric BP is illustrated as a penalty function for an expected delay in a container bot 110 time Tf of finishing a task relative to the task need time Tn. The penalty function may have the quadratic form:

$$P ( y ) = {( y - 1 )}^{p} where \qquad [ eq . 1 ]$$

$$y = \frac{( Tf - Tn )}{dT} \qquad [ eq . 2 ]$$

and dT is a time interval that reflects an uncertainty in estimating the finishing time Tf. The uncertainty is be based on a presence of other container bots 110 with trajectories partially overlapping with a planned trajectory of the container bot 110 with the need time Tn, and the need to de-conflict the container bot 110 with the need time Tn with other container bots 110 along/on its path. Suitable examples of trajectory/path generation and/or planning may be found in U.S. Pat. No. 11,117,743 issued on Sep. 14, 2021 (U.S. application Ser. No. 16/144,668 filed Sep. 27, 2018) and titled “Storage and Retrieval System,” U.S. provisional patent application No. 63/558,415 filed on Feb. 27, 2024 and titled “System and Method for Planning Operations of Large-scale Autonomous Vehicle Fleet,” and U.S. provisional patent application No. 63/631,176 filed on Apr. 8, 2024 and titled “System and Method for Priority Based Management of Autonomous Vehicle Fleet,” the disclosures of which are incorporated herein by reference in their entireties. The penalty function P should be zero when an expected finishing time Tf is substantially earlier than the need time Tn. The penalty function P monotonically and rapidly increases as the finishing time Tf becomes later than the need time Tn. Due to the above-noted uncertainty, the penalty function P becomes positive before the finishing time Tf reaches the need time Tn, such as where

$$Tf > Tn - dT \qquad [ eq . 3 ]$$

The penalty function P may be determined for both priority solutions (i.e., where two container bots 110 are assigned entry to the same storage aisle 130A to pick their corresponding cases and then travel to respective destination driveways/piers 130PR, and where two container bots 110 deliver cases to the same outbound driveway/pier 130PR from different storage aisles 130A), and the solution with the smaller penalty function may be chosen by the controller 120 (and/or the warehouse management system 2500) and/or the level controller 120L.

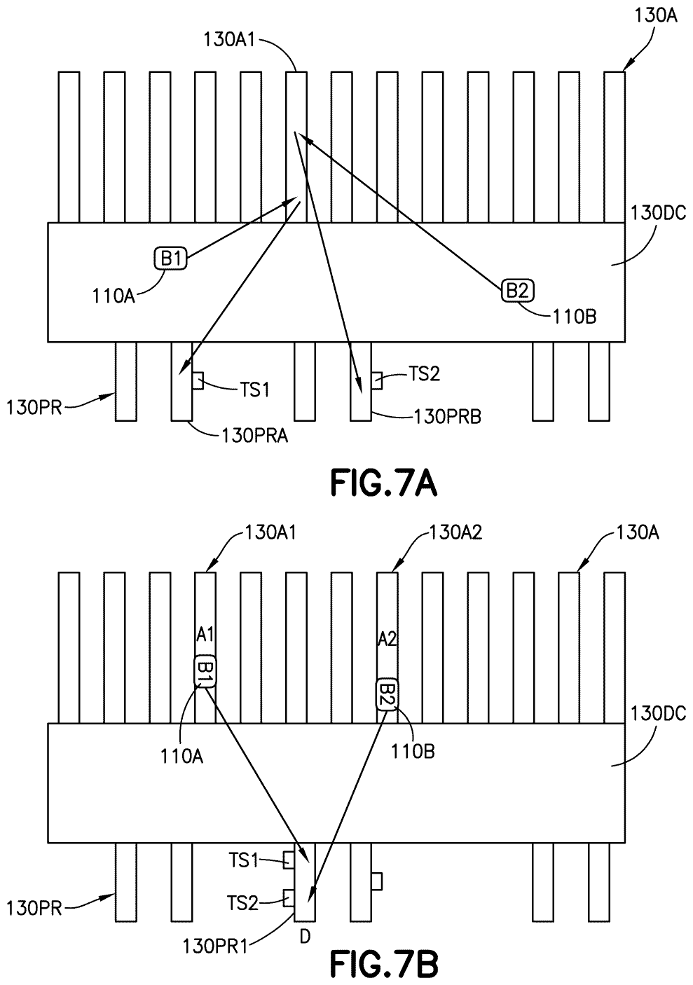

Referring also to FIGS. 7A and 7B, exemplary illustrations of container bot 110 tasks are illustrated, and for which tasks a penalty function P may be determined. In FIG. 7A two container bots 110A, 110B are shown for exemplary purposes only (there may be more than two container bots 110). The two container bots 110A, 110B have tasks assigned to pick cases from picking aisle 130A1. After picking a case from picking aisle 130A1, the container bot 110A is to deliver the case to pier 130PRA. After picking a case from picking aisle 130A1, the container bot 110B is to deliver the case to pier 130PRB. As illustrated, both container bots 110A, 110B must enter the same picking aisle 130A1 to pick the respective cases, where one of the container bots 110A, 110B is to wait outside the picking aisle 130A1 until the other container bot 110A, 110B finishes its picking task and leaves the picking aisle 130A1. In the example illustrated in FIG. 7A, there may be two priority solutions, i.e., a priority solution where container bot 110A enters the picking aisle 130A1 to complete the picking task first or a priority solution where container bot 110B enters the picking aisle 130A1 to complete the picking task first. Which priority solution is selected may be based on a total penalty function

$$P = P 1 + P 2 where \qquad [ eq . 4 ]$$

$$P 1 = P ( T 1 f - T 1 n ) and \qquad [ eq . 5 ]$$

$$P 2 = P ( t 2 f - t 2 n ) \qquad [ eq . 6 ]$$

where T1f and T2f are expected task finishing times for container bots 110A, 110B respectively; and T1n and T2n are respective need times for the tasks assigned to the container bots 110A, 110B. The task finishing times may be determined for each of the two priority solutions (noted above) as follows:

For container bot 110A entering the picking aisle 130A1 first:

$$T 1 f = T 1 a + T 1 d \qquad [ eq . 7 ]$$

$$T 2 f = T 1 a + T 2 {a}^{′} + T 2 d \qquad [ eq . 8 ]$$

where: T1a is the time needed for the container bot 110A to enter the picking aisle 130A1, pick the assigned case, and exit the picking aisle 130A1; T1d is the time for container bot 110A to get from the picking aisle 130A1 to the pier 130PRA and place the container on a predetermined transfer station TS1; T2a′ is the time needed for the container bot 110B to enter the picking aisle 130A1 from its waiting position after container bot 110A exits the picking aisle 130A1, pick the assigned case, and exit the picking aisle 130A1; and T2d is the time needed for container bot 110B to get from the picking aisle 130A1 to pier 130PRB and place the case on a predetermined transfer station TS2.

For container bot 110B entering the picking aisle 130A1 first:

$$T 2 f = T 2 a + T 2 d \qquad [ eq . 9 ]$$

$$T 1 f = T 2 a + T 1 {a}^{′} + T 1 d \qquad [ eq . 10 ]$$

where T1a′ is the time needed for the container bot 110A to enter the picking aisle 130A1 from its waiting position after container bot 110B exits the picking aisle 130A1, pick the assigned case, and exit the picking aisle 130A1.

In FIG. 7B two container bots 110A, 110B are shown for exemplary purposes only (there may be more than two container bots 110). The two container bots 110A, 110B have tasks assigned to deliver cases to the same outbound pier 130PR1 from the picking aisles 130A1, 130A2 respectively. The container bot 110B is to place its case on a predetermined transfer station TS2 that is deeper into the pier 130PR1, so both container bots 110A, 110B may be present in the pier 130PR1 at the same time. In the example illustrated in FIG. 7B, there may be two priority solutions, i.e., a priority solution where container bot 110A enters the pier 130PR1 to complete the delivery task first or a priority solution where container bot 110B enters the pier to complete the delivery task first. Which priority solution is selected may be based on a total penalty function, see equations [4], [5], and [6] above.

The task finishing times are determined for both priority solutions (i.e., where container bot 110A enters the pier 130PR1 to complete the delivery task first or a priority solution where container bot 110B enters the pier to complete the delivery task first) as follows:

For container bot 110A entering the pier 130PR1 first:

$$T 1 f = T 1 d \qquad [ eq . 11 ]$$

$$T 2 f = T 1 e + T 2 {d}^{′} \qquad [ eq . 12 ]$$

where: T1d is the time needed for container bot 110A to go from picking aisle 130A1 to pier 130PR1 and place its case on the predetermined transfer station TS1; T1e is the time needed for container bot 110A not only to place its case on the transfer station TS1, but also exit the pier 130PR1 (T1e is larger than T1d); and T2d′ is the time needed for container bot 110B to go from its waiting position (which may or may not be in picking aisle 130A2) to pier 130PR1 and place its case to the predetermined transfer station TS2 after container bot 110A exits the pier 130PR1.

For container bot 110A entering the pier 130PR1 first:

$$T 2 f = T 2 d \qquad [ eq . 13 ]$$

$$T 1 f = max ( T 1 d , T 2 d ) \qquad [ eq . 14 ]$$

where: T1f=max(T1d, T2d) is because the container bot 110A must enter pier 130PR after container bot 110B; and T2d is the time needed for container bot 110B to go from the picking aisle 130A2 to the pier 130PR1 and place its case on the transfer station TS2.

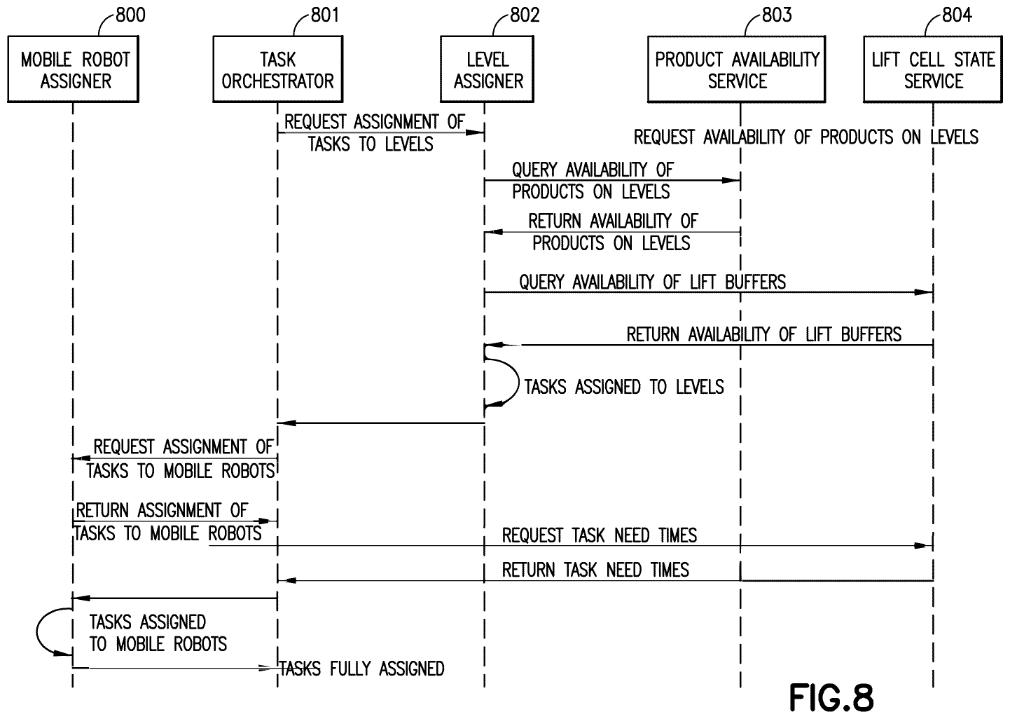

Referring to FIGS. 1 and 8, exemplary communications between components managing operations of the at least the container bots 110 and the lifts 150 are illustrated. The components include a mobile robot assigner module 800, a task orchestrator module 801, a level assigner module 802, a product availability service module 803, and a lift cell state service module 804. The a mobile robot assigner module 800, a task orchestrator module 801, a level assigner module 802, a product availability service module 803, and a lift cell state service module 804 may reside in one or more of the controller 120, warehouse management system 2500, and level controller 120L. The task orchestrator module 801 is configured to manage all tasks of delivery of products/cases to the transfer stations TS of the lifts 150. The task orchestrator module 801 may request the level assigner module 802 to distribute tasks between storage levels 130L. The level assigner module 802 may query the product availability service module 803 to determine availability of cases on each storage level 130L for completing each task. The level assigner module 802 may query the lift cell state service module 804 to determine which storage levels 130L, with the available cases thereon for each task, have free transfer stations TS to place the cases to. With the information regarding the case availability and the transfer station availability for each task, the level assigner module 802 may employ any suitable combinatoric optimization algorithm to distribute tasks between the levels 130L so that the levels 130L will have a reasonable, and substantially equal, number of tasks assigned where the assigned levels 130L have available cases and available transfer stations TS.

With the level 130L assignments established, the task orchestrator module 801 requests the lift cell state service module 804 to provide the need times Tn for each task assigned at each of the storage levels 130L for specific/predetermined transfer stations TS. The task orchestrator module 801 requests the mobile robot assigner module 800 at each of the assigned storage levels 130L to assign tasks to the container bots 110 for completing the tasks to the predetermined transfer stations TS of the respective storage level 130L. With all tasks assigned to the container bots 110 on the assigned storage levels 130L, the tasks may be considered fully assigned and the container bots 110 are instructed to execute the respectively assigned tasks.

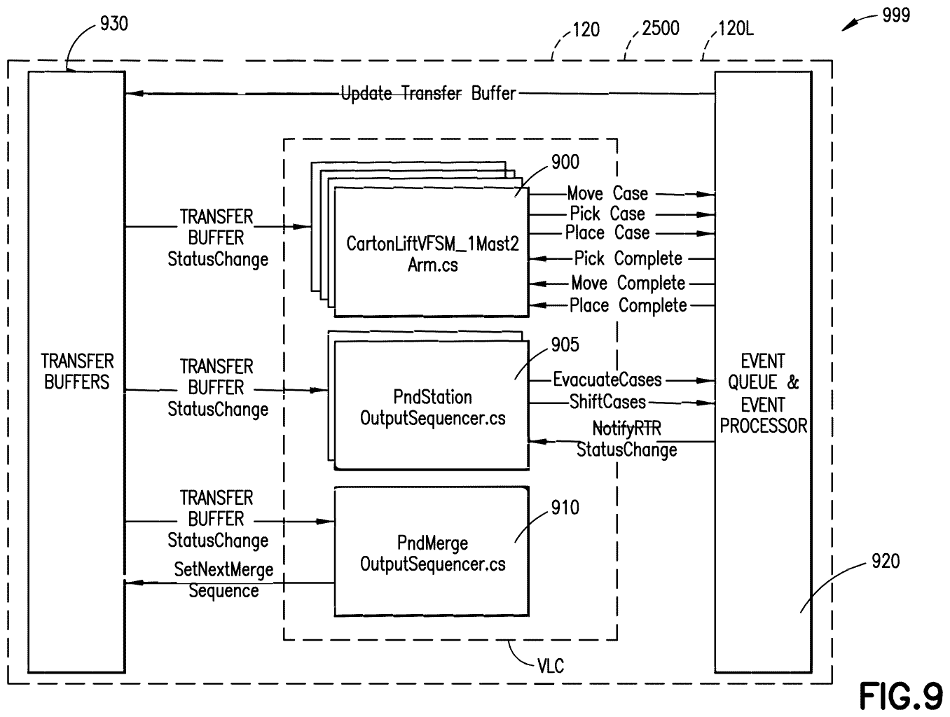

Referring to FIGS. 1, 4, 5A, 5B, and 9, the one or more of the controller 120, warehouse management system 2500, and level controller 120L (or any other suitable controller of the product order fulfillment system 100) may include, what may be referred to as a lift cell trajectory generator and assignment module 999 that includes or otherwise communicates with a vertical lift control VLC. The vertical lift control VLC includes one or more of a lift finite state machine module 900 (which may be included in or provided separate of the lift cell state service module 804), a common output sequencer module 905, and a common output merge sequencer 910. The lift cell trajectory generator and assignment module 999 may also include an event queue and processor 920 (provided in one or more of the controller 120, warehouse management system 2500, and level controller 120L (or any other suitable controller)) and a memory 930. The event queue and processor 920 effects the processing and queuing of case transfer actions (e.g., moving, placing, and picking cases). The event queue and processor 920 may also update a status of a transfer stations TS (also referred to as a transfer buffer-such status being stored in the memory 930) based on, for example, the processing or queuing of the case transport events. The lifts 150 may be commanded to pick cases from the respective transfer stations TS at a predetermined storage level 130L, move the cases vertically along the trajectory TJ, and place the cases on the common output 300.

The event queue and processor 920 may subscribe to a persistent messaging queue to receive transfer station TS status messages from, for example, one or more of the controller 120, level controller 120L, and warehouse management system 2500. Transfer station TS status messages are published whenever a case or a group of cases is added to or removed from a transfer station TS, or when the transfer station is marked suspect, reserved or available. The transfer station TS status messages include an identifier for the case(s) currently located on the transfer station TS (if any) along with its sequence number and other data employed to control a lift 150. The event queue and processor 920 may store the most recent state of each buffer in any suitable memory 930 accessible to the event queue and processor 920. The lift cell trajectory generator and assignment module may be scaled by running multiple instances, which access the same memory 930 for reading and writing data. The event queue and processor 920 may also subscribe to tasks leveled messages from the Task Orchestrator module 801 (see FIG. 8), which are published whenever the set of tasks assigned to transfer buffers TS for any palletizing robot 160PB destination changes.

When the event queue and processor 920 receives a message including a new set of tasks (see FIG. 8), which have been assigned to transfer stations TS, the event queue and processor 920 begins a determination cycle including the following: querying a vertical lift control VLC for lift cell 150CEL hardware state data (which data includes the last sequence of cases evacuated from the lift cell 150CEL, the operational state of each lift 150 in the lift cell 150CEL, the operation state of the common output 300, and the operation state of the merge (e.g., see FIG. 4 where the cases travelling along the traverses 550 are merged with one another by the conveyor section 160CBT) at the common output 300); see discrete even simulation (such as by the event queue and processor 920) with the current state of the transfer stations TS and lift cell 150CEL hardware; run discrete event simulation, updating the memory 930 as predictions (determinations of the qualitative metrics such as need times and priority/delay penalties) are made for the transfer stations; and publish messages indicating that the predictions have been updated for a predetermined palletizing robot destination.

The lift cell trajectory generator and assignment module 999 may employ a concurrent threading model and is configured to perform calculation cycles in parallel for different palletizing robot 160PB destinations. The discrete event simulation is enabled by the lift cell trajectory generator and assignment module 999 consuming a “Core Logic” software package from the vertical lift control VLC which includes the finite-state machine classes (e.g., from the lift finite state machine module 900) that define the behavior for controlling each lift 150 as well as a separate “common output Merge Sequencer” class (e.g., from the common output merge sequencer 910) which controls sending commands to shift cases along or evacuate cases from the common output 300. These classes call into software interfaces of the lift cell trajectory generator and assignment module 999 to issue move/pick/place/shift/evacuate commands, and the implementation of the interfaces is injected into the classes at runtime.

When a calculation cycle begins, the lift finite state machine module 900, common output sequencer module 905, and common output merge sequencer 910 are seeded with current state of the transfer stations TS and lift cell 150CEL hardware, and allowed to run. When the lift finite state machine module 900, common output sequencer module 905, and common output merge sequencer 910 issue a command, it is intercepted and placed on an event queue (e.g., in the event queue and processor 920). The lift cell trajectory generator and assignment module 999 implements a hardware simulator which determines the time required to execute each command in the context of the simulated lift cell's 150CEL current state. The event queue is processed sequentially, and when an event is processed which would change the state of a transfer station TS (e.g. a lift picking from a transfer station TS), a transfer station TS state change event is sent to the lift finite state machine module 900, common output sequencer module 905, and common output merge sequencer 910, which may result in new commands being sent to the event queue. As events are processed, a simulation timer is also incremented to provide accurate times for the transfer station TS state change events.

For tasks, which have been assigned to a transfer station but not delivered by a container bot 110, the simulation includes the task sequence as starting on the assigned transfer station TS, and separately tracks whether and when the lift 150 is commanded to pick the task's simulated case. This time may be recorded as the need time Tn for the task. For cases, which are already on the transfer station, the time that the simulated lift 150 picks them is similarly recorded.

The lift cell trajectory generator and assignment module 999 may provide an endpoint, which allows any suitable external services to query the current state and need time (lift pickup times) of all transfer stations associated with either a palletizing robot 160PB destination or structural level 130L. The lift cell trajectory generator and assignment module 999 may also provide an endpoint through which the current hardware state of the lifts 150, common outputs 300 and merges can be requested.

With reference to FIGS. 1, 4, 5A, 5B, 8, and 9, outbound tasks (such as case transfer to the output stations 160UT) are assigned first to transfer stations TS on different levels 130L, and then to (at least) container bots 110 by different task assignment services (such as the level assigner module 802 and mobile robot assigner module 800, respectively). Each service is configured to solve an optimization problem under various constraints in order to generate assignments. The lift cell trajectory generator and assignment module 999 provides the constraint data of which transfer stations TS and lift cell 150CEL devices are available for assignment. The lift cell trajectory generator and assignment module 999 may provide feedback based on prior assignment results that guide the prioritization of future assignments. For the level assigner module 802, the lift cell trajectory generator and assignment module 999 indicates when currently-occupied transfer stations TS will be cleared by the lift 150 and available for the next case. The level assigner module 802 may then employ this information to steadily meter assignments to the transfer stations TS. For the mobile robot assigner module 800, there are typically more tasks assigned to a level 130L than there are container bots 110 on the level 130L. The need times Tn provided by the lift cell trajectory generator and assignment module 999 allow the mobile robot assigner module 800 to prioritize tasks for assignment to the contain bots 110 in conjunction with mobile robot state predictions provided by a different service. This feedback mechanism may prevent lift cell 150CEL starvation and allow the task assignment services to make assignments over a longer time window without unbalancing the distribution of tasks to lift cells 150CEL

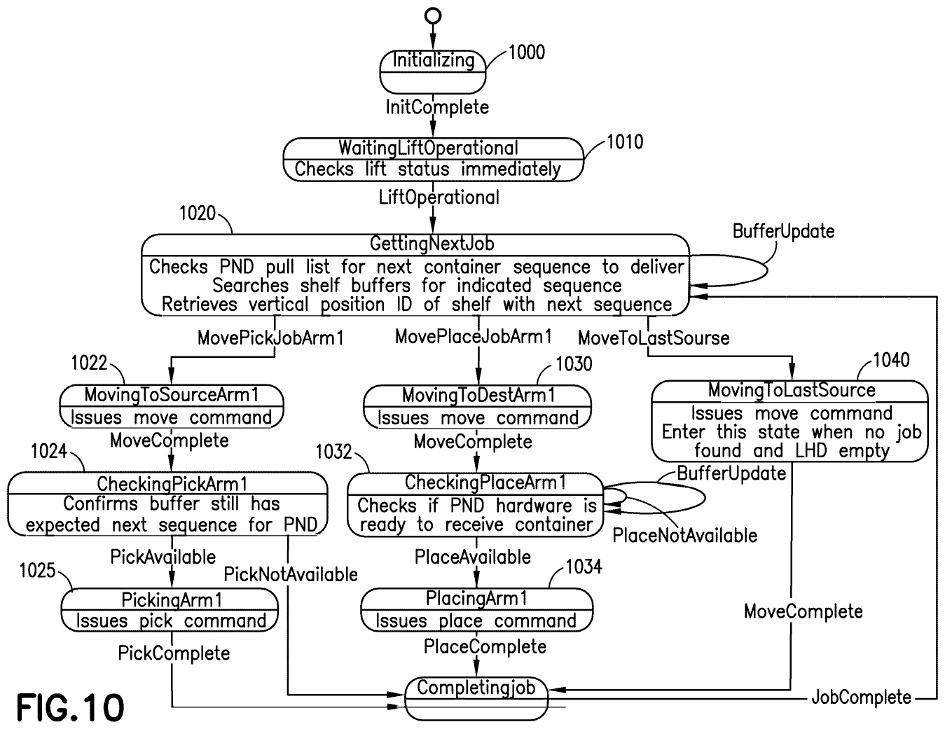

Referring to FIGS. 1, 4, 5A, 5B, 8, and 10, a process flow of transferring cases with one or more lift axis 150X1-150Xn of a lift cell 150CEL will be described. The lift cell 150CEL is initialized (FIG. 10, Block 1000). The status of each lift 150B (corresponding to the lift axes 150X1-150Xn) in the lift cell 150CEL is checked such as by the lift cell state service module 804 (see FIG. 8) (FIG. 10, Block 1010). A common output 300 “pull list” (e.g., which cases are required for the predetermined case out ordered sequence of mixed cases PSMX) is queried (such as by the common output sequencer module 905) for a next case in the case sequence to deliver to the common output, the transfer stations TS accessible by the lifts 150B of the lift cell 150CEL are searched for the next case, and the vertical position identification of the transfer station TS having the next case is retrieved (FIG. 10, Block 1020). The controller 120 (or warehouse management system 2500 or any suitable lift cell controller) issues a lift 150B, associated with the transfer stations TS on which the next case is disposed, a move command (FIG. 10, Block 1022) to pick the next case. The sequence of the next case, disposed on the transfer station, in the sequence of cases on the common output 300 is confirmed (such as by or with the common output sequencer module 905) (FIG. 10, Block 1024) and the next case is picked by the lift 150B (FIG. 10, Block 1025).

With the next case held by the load handling device LHD of the lift 150B, the controller 120 (or warehouse management system 2500 or any suitable lift cell controller) issues the lift 150B a command to place the next case on the common output 300 (FIG. 10, Block 1030). It is determined by the controller 120 (or warehouse management system 2500 or any suitable lift cell controller) that the common output 300 is ready to receive the next case (FIG. 10, Block 1032) and the lift 150B places the case to the common output 300 (FIG. 10, Block 1034). With the load handling device LHD of the lift 150B empty and no case transport even planned for the lift 150B, the lift may be commanded to move away from the common output 300 to the location of the last pick location or any other suitable location to wait for a next case transport event (FIG. 10, Block 1040).

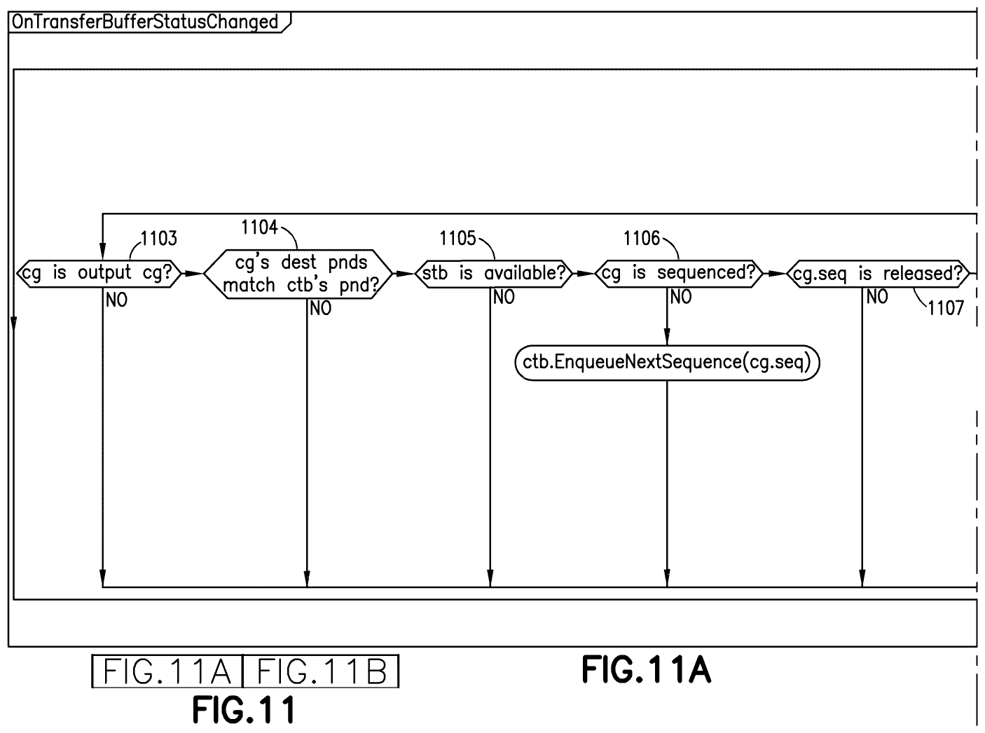

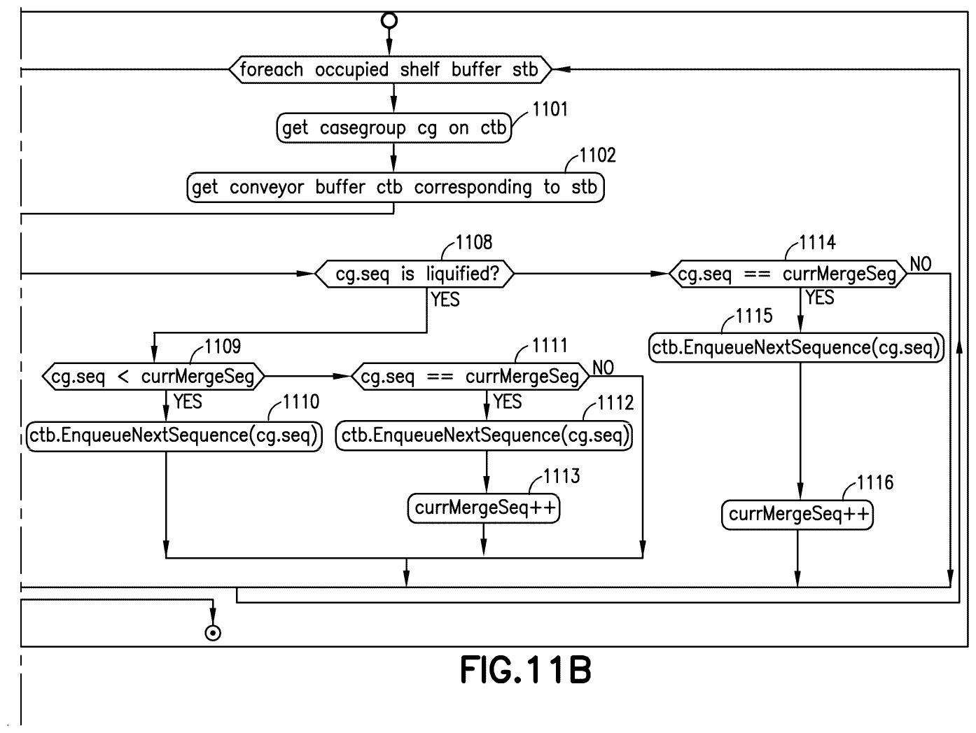

Referring to FIGS. 1, 4, 5A, 5B, 8, and 11 and exemplary transfer station TS status change determination will be described. For each transfer station TS holding a case in a lift cell 150CEL, the case identification of the case on the transfer station TS is obtained by the controller 120 (or warehouse management system 2500 or any suitable lift cell controller) (FIG. 11, Block 1101). The controller 120 (or warehouse management system 2500 or any suitable lift cell controller) obtains the location on the common output 300 corresponding to the transfer station (FIG. 11, Block 1102). The controller 10 (or warehouse management system 2500 or any suitable lift cell controller) determines that the case at the transfer station TS is the case designated for output (FIG. 11, Block 1103) according to the predetermined case out ordered sequence of mixed cases PSMX. The controller 120 (or warehouse management system 2500 or any suitable lift cell controller) determines if the location destination of the case on the common output 300 matches the location of the common output determined in block 1102 (FIG. 11. Block 1104). It is confirmed that the case is still available on the transfer shelf TS (FIG. 11, Block 1105) and that the case is sequenced in the predetermined case out ordered sequence of mixed cases PSMX (FIG. 11, Block 1106). It is confirmed that the case sequence is released (e.g., for placement on the common output 300) (FIG. 11, Block 1107) and that the case is ready for placement in the case sequence (FIG. 11, Block 1108). Where the sequence number of the case is less than a current merge sequence number the case is not transferred to the common output 300 (FIG. 11, Blocks 1109, 1110) and the status of the transfer station remains as occupied. Where the sequence number of the case is the same as the current merge sequence number the case is transferred to the common output 300 (FIG. 11, Blocks 1111, 1112, 1113 or 1114, 1115, 1116) and the status of the transfer station is changed to available.

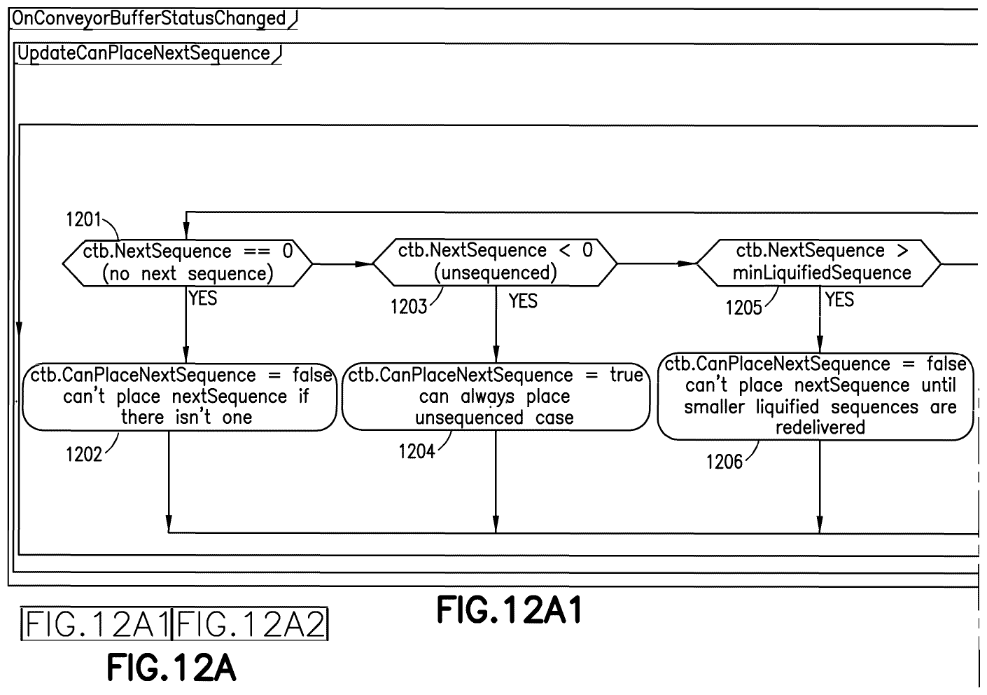

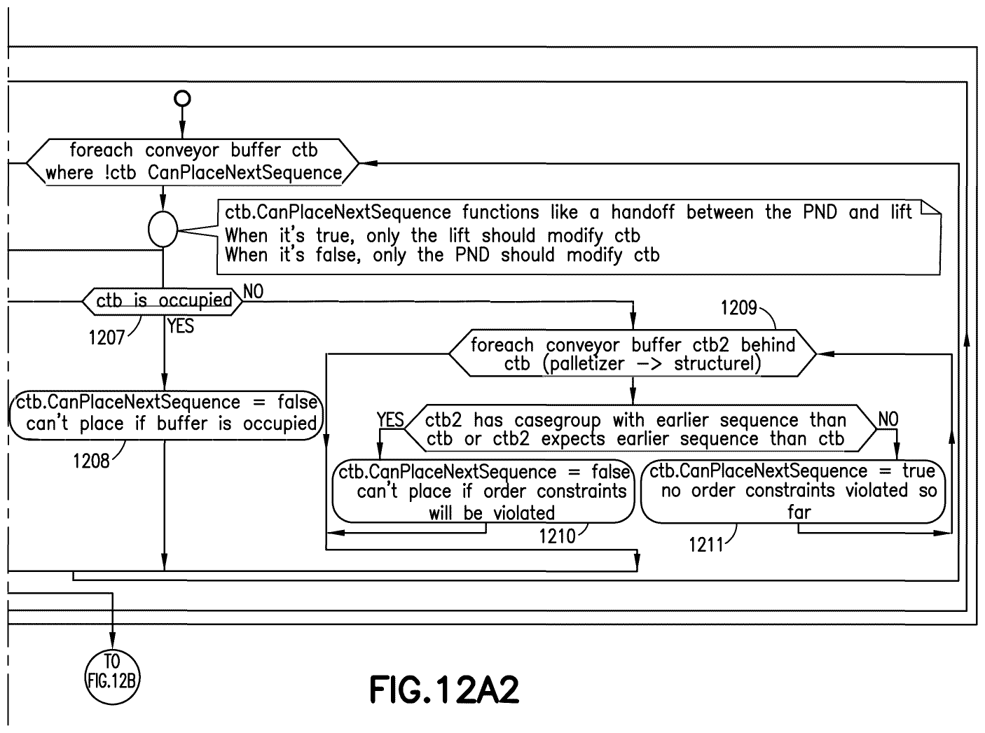

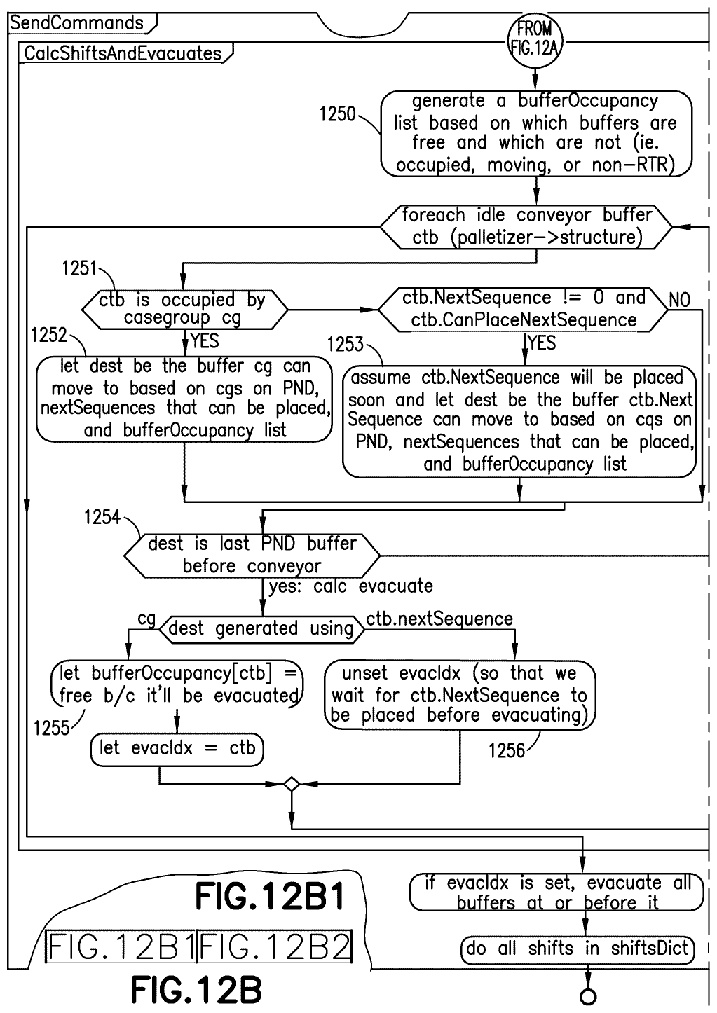

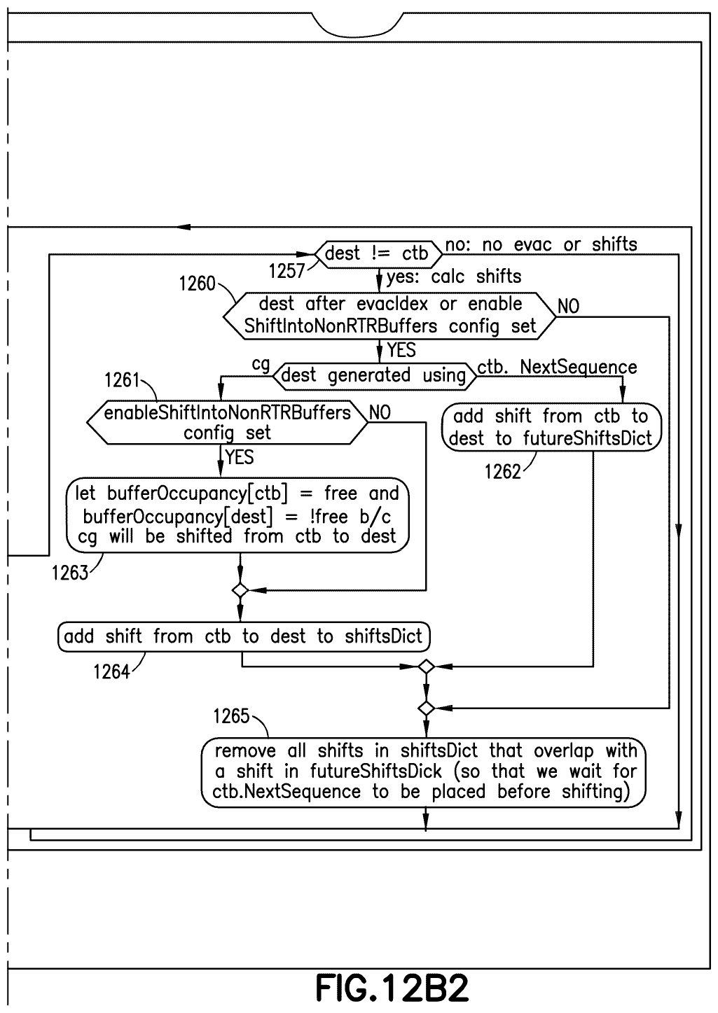

Referring to FIGS. 1-7 and FIGS. 12A and 12B a determination, such as by the controller 120 (or warehouse management system 2500 or vertical lift control VLC), for placing a next case CUN, in the predetermined case out ordered sequence of mixed cases PSMX, on the common output 300 will be described. Spaces on the common output 300 at which cases may be placed may be referred to as conveyor buffers CTB (see FIG. 5B). For each conveyor buffer CTB at which the next case CUN can be placed it is determined if an ordered sequence of mixed cases SMX is being placed (FIG. 12A, Block 1201), where if there is no ordered sequence of mixed cases SMX of cases being placed the next case CUN will not be transferred to the common output (FIG. 12A, Block 1202). Where there is an ordered sequence of mixed cases SMX, it is determined if the next case CUN is sequenced or not sequenced (FIG. 12A, Block 1203), where non-sequenced cases can be placed on the common output 300 (FIG. 12A, Block 1204). Where the next case CUN is sequenced, it is determined if the place sequence of the next case CUN is ready for execution (FIG. 12A, Block 1205), where if the place sequence of the next case CUN is not ready for execution, the next case CUN is not placed on the common output 300 (FIG. 12A, Block 1206). With the place sequence of the next case CUN being ready for execution, it is determined if the conveyor buffer CTB of the common output 300 is occupied (FIG. 12A, Block 1207), where if the conveyor buffer CTB is occupied, the next case CUN is not placed on the common output 300 (FIG. 12A, Block 1208). Where the conveyor buffer CTB is not occupied, it is determined if upstream conveyor buffers CTBU (see FIG. 5B), relative to the lift 150 placing the next case CUN, is holding a case that has an earlier sequence number than the next case CUN (FIG. 12A, Block 1209; in FIG. 5B, for exemplary purposes only, the next case CUN has sequence number n+5 while the upstream case has sequence number n+6). Where the upstream conveyor buffers CTBU hold or are expecting to hold a case with an earlier sequence number than the next case CUN, the next case CUN is not placed on the common output at conveyor buffer CTB (FIG. 12A, Block 1210). Where the upstream conveyor buffers CTBU do not hold or are not expecting to hold a case with an earlier sequence number than the next case CUN, the next case CUN is placed on the common output at conveyor buffer CTB (FIG. 12A, Block 1211).

It may be determined, such as by the controller 120 (or warehouse management system 2500 or vertical lift control VLC), whether cases are shifted from one conveyor buffer CTB to another conveyor buffer CTB to effect sequencing/resequencing of cases on the common output 300. Here, a buffer occupancy (of conveyor buffers CTB) list is generated based on the conveyor buffers CTB that are free/idle (i.e., not occupied by a case, not ready to receive a case, or moving) (FIG. 12B, Block 1250). For each idle conveyor buffer CTB, it is determined if the conveyor buffer is occupied by a case (FIG. 12, Block 1251). If the conveyor buffer is occupied by a case, a destination is set to be the conveyor buffer the case can move to based on the cases disposed on the common output 300, the next sequences that can be placed, and the buffer occupancy list (FIG. 12B, Block 1252). Where the conveyor buffer CTB is not occupied and the next sequence can place the case to the conveyor buffer CTB, the destination is set to the conveyor buffer the next sequence can move to based on the cases disposed on the common output 300, the next sequences that can be placed, and the conveyor buffer occupancy list (FIG. 12B, Block 1253). With the destination set, it is determined in the destination is the last conveyor buffer available for placing a case in the lift cell 150CEL (i.e., the location at which lift axis 150X1 can place a case) (FIG. 12B, Block 1254). Where the destination is the last conveyor buffer, the case is evacuated from the lift cell 150CEL by the common output 300 (FIG. 12A, Blocks 1255, 1256). Where the destination is not the last conveyor buffer CTB in the lift cell 150CEL and not occupied, not moving, or ready to receive (FIG. 12B, Block 1257) the case evacuation or shifts may not be needed for case placement. Where the destination is not the last conveyor buffer CTB in the lift cell 150CEL and is occupied, moving, or not ready to receive the destination is shifted to a free conveyor buffer after case evacuation or to a not ready to receive conveyor buffer (FIG. 12B, Blocks 1260-1265).

Referring to FIGS. 1-7 and 13, an exemplary conveyor buffer status change will be described. For each conveyor buffer CTB (see FIG. 5B) it is determined if the pickface/case identification on the conveyor buffer CTB matches the pickface/case identification of the conveyor buffer CTB (e.g., the case held on the conveyor buffer is the correct case-FIG. 13, Block 1310). Where the case identification does not match the case identification assigned to the conveyor buffer CTB, the destination is set to the conveyor buffer such that the case identification and the case identification assigned to the conveyor buffer match (FIG. 13, Block 1312). If the destination does not exist it is assumed the case has been evacuated and the conveyor buffer properties are updated (FIG. 13, Block 1325). If the destination exists the case is case identification assigned to the conveyor buffer shifted from the conveyor buffer to the destination and the destination properties are updated (FIG. 13, Block 1330). If the status of the conveyor buffer has changed the conveyor buffer properties are updated (FIG. 13, Blocks 1335, 1336).

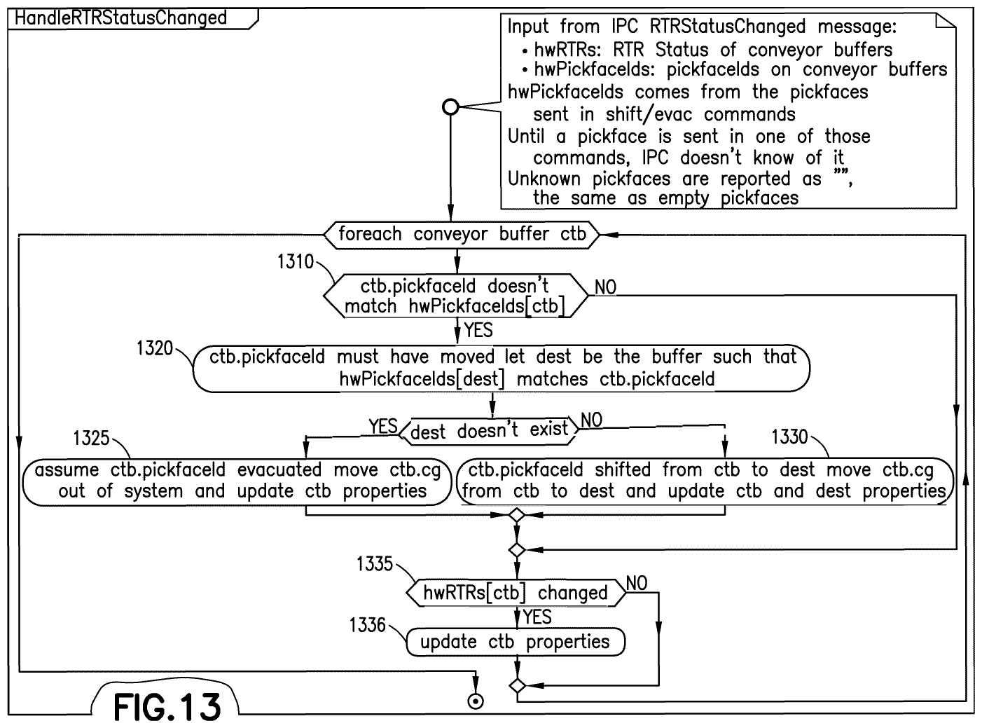

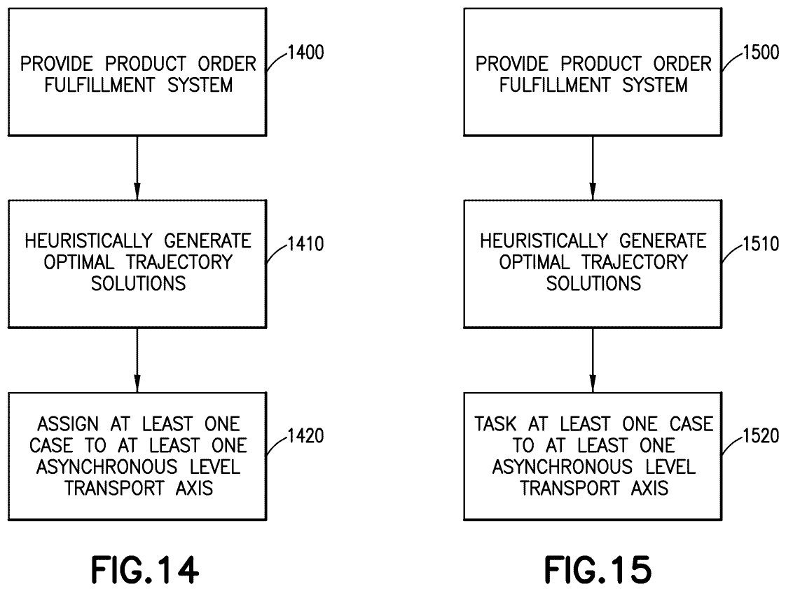

Referring to FIGS. 1-7 and 14, and exemplary method will be described in accordance with the present disclosure. The product order fulfillment system 100 is provided (FIG. 14, Block 1400). The product order fulfillment system 100 is as described herein and includes, for example, the multi-level transport system MTS, the lifting transport system 500, the controller (inclusive of one or more of the controller 120, level controller 120L, and warehouse management system 2500).

Each level 130L of the multi-level transport system MTS has a corresponding independent asynchronous level transport system ALM, of mixed cases, separate and distinct from the asynchronous level transport system ALM corresponding to each other level 130L of the multi-level transport system MTS. The asynchronous level transport system ALM, of each level 130L, defines an array of asynchronous level transport axes, corresponding to the level 130L. The asynchronous level transport system ALM, of each level 130L, is configured to hold and asynchronously transport at least one case providing transport of mixed cases along the array of asynchronous level transport axes. The lifting transport system 500 includes more than one independent lift axis 150X1-150Xn (see, e.g., FIGS. 5A and 5B) in a common lift cell 150CEL. Each of the more than one independent lift axis 150X1-150Xn is configured to independently hold and transport at least one case along a trajectory TJ, independently of each other independent lift axis 150X1-150Xn, so that the trajectory TJ, of the at least one case on the respective lift axis 150X1-150Xn, is asynchronous from each other respective trajectory TJ of each other independent lift axis 150X1-150Xn of the common lift cell 150CEL effecting transport of mixed cases from the array of asynchronous level transport axes. The asynchronous trajectories TJ of the common lift cell 150CEL output the ordered sequence of mixed cases SMX in accordance to the predetermined case out ordered sequence of mixed cases PSMX.

The controller is operably coupled to the multi-level transport system MTS and the lifting transport system 500. The controller is configured to heuristically generate optimal trajectory solutions for the asynchronous trajectories TJ (FIG. 14, Block 1410), and assign the at least one case to at least one asynchronous level transport axis ALM (FIG. 14, Block 1420) based on at least one qualitative metric QM characterized by the optimal trajectory solutions. Assignment of the at least one case to the at least one asynchronous level transport axis ALM is resultant from the heuristic determination of the at least one qualitative metric MQ characterized by the optimal trajectory solution. The controller (such as at the storage structure level—level controller 120L) applies the at least one qualitative metric QM, generated by, for example, a higher level controller such as the controller 120, to the assignment so that the assignment is based on/depends on the qualitative metric QM. The assignment may be considered a final part of the optimal trajectory solution that directs the autonomously guided vehicle 110 to a case destination based on the qualitative metric QM.

The method may include on or more of the following, which may be employed individually, in any combination with each other, and/or in any combination with the features described above: the more than one independent lift axis 150X1-150Xn comprises a reciprocating axis; each independent lift axis 150X1-150Xn, of the more than one lift axis 150X1-150Xn, is communicably coupled to each other independent lift axis 150X1-150Xn of the more than one lift axis 150X1-150Xn of the common lift cell 150CEL and forms a common output 300 of the common lift cell 150CEL, where, with the common output 300, the ordered sequence of mixed cases SMX is output in accordance to the predetermined case out ordered sequence PSMX of mixed cases; the qualitative metric QM is a need time Tn for the at least one case at a predetermined destination of the asynchronous level transport system ALM of a corresponding level 130L; the predetermined destination is a transfer station TS communicably coupling the asynchronous level transport system ALM and a corresponding independent lift axis 150X1-150Xn of the more than one independent lift axis 150X1-150Xn; and the qualitative metric QM is a parametrized delay penalty metric BP describing effects in the asynchronous level transport from delays from a need time Tn.

Referring to FIGS. 1-7 and 15, and exemplary method will be described in accordance with the present disclosure. The product order fulfillment system 100 is provided (FIG. 15, Block 1500). The product order fulfillment system 100 is as described herein and includes, for example, the multi-level transport system MTS, the lifting transport system 500, the controller (inclusive of one or more of the controller 120, level controller 120L, and warehouse management system 2500).

Each level 130L of the multi-level transport system MTS has a corresponding independent asynchronous level transport system ALM, of mixed cases, separate and distinct from the asynchronous level transport system ALM corresponding to each other level 130L of the multi-level transport system MTS. The asynchronous level transport system ALM, of each level 130L, defines an array of asynchronous level transport axes, corresponding to the level 130L. The asynchronous level transport system ALM, of each level 130L, is configured to hold and asynchronously transport at least one case providing transport of mixed cases along the array of asynchronous level transport axes. The lifting transport system 500 includes more than one independent lift axis 150X1-150Xn (see, e.g., FIGS. 5A and 5B) in a common lift cell 150CEL. Each of the more than one independent lift axis 150X1-150Xn is configured to independently hold and transport at least one case along a trajectory TJ, independently of each other independent lift axis 150X1-150Xn, so that the trajectory TJ, of the at least one case on the respective lift axis 150X1-150Xn, is asynchronous from each other respective trajectory TJ of each other independent lift axis 150X1-150Xn of the common lift cell 150CEL effecting transport of mixed cases from the array of asynchronous level transport axes. The asynchronous trajectories TJ of the common lift cell 150CEL output the ordered sequence of mixed cases SMX in accordance to the predetermined case out ordered sequence of mixed cases PSMX.

The controller is operably coupled to the multi-level transport system MTS and the lifting transport system 500. The controller is configured to heuristically generate optimal trajectory solutions for the asynchronous trajectories TJ (FIG. 15, Block 1510), and tasking the at least one case to at least one asynchronous level transport axis ALM (FIG. 15, Block 1520) characterized with at least one qualitative metric QM described by the optimal trajectory solution. Here, tasking is effected at a higher level than the assignment of the at least one case to the at least one asynchronous level transport axis ALM. In tasking, the controller (such as the controller 120) determines the at least one qualitative metric QM (e.g., one or more of a need time Tn, a parametrized delay penalty metric BP, and a bot path priority) and provides the task alongside/with the at least one qualitative metric QM to a lower level controller (such as the level controller 120L) for a determination of which autonomously guided vehicle 110 of a fleet of autonomously guided vehicles can execute/fulfill/complete the task. With the autonomously guided vehicle selected, the level controller 120L may assign the task as noted herein.

The method may include on or more of the following, which may be employed individually, in any combination with each other, and/or in any combination with the features described above: the more than one independent lift axis 150X1-150Xn comprises a reciprocating axis; each independent lift axis 150X1-150Xn, of the more than one lift axis 150X1-150Xn, is communicably coupled to each other independent lift axis 150X1-150Xn of the more than one lift axis 150X1-150Xn of the common lift cell 150CEL and forms a common output 300 of the common lift cell 150CEL, where, with the common output 300, the ordered sequence of mixed cases SMX is output in accordance to the predetermined case out ordered sequence PSMX of mixed cases; the qualitative metric QM is a need time Tn for the at least one case at a predetermined destination of the asynchronous level transport system ALM of a corresponding level 130L; the predetermined destination is a transfer station TS communicably coupling the asynchronous level transport system ALM and a corresponding independent lift axis 150X1-150Xn of the more than one independent lift axis 150X1-150Xn; and the qualitative metric QM is a parametrized delay penalty metric BP describing effects in the asynchronous level transport from delays from a need time Tn.

The following are provided in accordance with the present disclosure and may be employed individually, in any combination with each other, and/or in any combination with the features described above.

In accordance with the present disclosure a product order fulfillment system includes: a multi-level transport system, each level thereof having a corresponding independent asynchronous level transport system, of mixed cases, separate and distinct from the asynchronous level transport system corresponding to each other level of the multi-level transport system, the asynchronous level transport system defining an array of asynchronous level transport axes, corresponding to the level, and being configured to hold and asynchronously transport at least one case providing transport of mixed cases along the array of asynchronous level transport axes; a lifting transport system with more than one independent lift axis, in a common lift cell, each of the more than one independent lift axis being configured to independently hold and transport the at least one case along a trajectory, independently of each other independent lift axis, so that the trajectory, of the lift, is asynchronous from each other respective trajectory of each other independent lift axis of the common lift cell effecting transport of mixed cases from the array of asynchronous level transport axes; and a controller operably coupled to the multi-level transport system and the lifting transport system; wherein the asynchronous trajectories of the common lift cell output an ordered sequence of mixed cases in accordance to a predetermined case out ordered sequence of mixed cases; and wherein the controller is configured to heuristically generate optimal trajectory solutions for the asynchronous trajectories, and assign the at least one case to at least one asynchronous level transport axis based on at least one qualitative metric characterized by the optimal trajectory solutions.

In accordance with the present disclosure, the product order fulfillment system includes one or more of: the more than one independent lift axis comprises a reciprocating axis; each independent lift axis, of the more than one lift axis, is communicably coupled to each other independent lift axis of the more than one lift axis of the common lift cell and forms a common output of the common lift cell that outputs the ordered sequence of mixed cases in accordance to the predetermined case out ordered sequence of mixed cases; the qualitative metric is a need time for the at least one case at a predetermined destination of the asynchronous level transport system of a corresponding level; the predetermined destination is a transfer station communicably coupling the asynchronous level transport system and a corresponding independent lift axis of the more than one independent lift axis; and the qualitative metric is a parametrized delay penalty metric describing effects in the asynchronous level transport from delays from a need time.

In accordance with the present disclosure a product order fulfillment system includes: a multi-level transport system, each level thereof having a corresponding independent asynchronous level transport system, of mixed cases, separate and distinct from the asynchronous level transport system corresponding to each other level of the multi-level transport system, the asynchronous level transport system defining an array of asynchronous level transport axes, corresponding to the level, and being configured to hold and asynchronously transport at least one case providing transport of mixed cases along the array of asynchronous level transport axes; a lifting transport system with more than one independent lift axis, in a common lift cell, each of the more than one independent lift axis being configured to independently hold and transport the at least one case along a trajectory, independently of each other independent lift axis, so that the trajectory, of the lift, is asynchronous from each other respective trajectory of each other independent lift axis of the common lift cell effecting transport of mixed cases from the array of asynchronous level transport axes; and a controller operably coupled to the multi-level transport system and the lifting transport system; wherein the asynchronous trajectories of the common lift cell output an ordered sequence of mixed cases in accordance to a predetermined case out ordered sequence of mixed cases; and wherein the controller is configured to heuristically generate optimal (min time) trajectory solutions for the asynchronous trajectories, and task the at least one case to at least one asynchronous level transport axis characterized with at least one qualitative (qualification) metric described by the optimal trajectory solution.

In accordance with the present disclosure, the product order fulfillment system includes one or more of: the more than one independent lift axis comprises a reciprocating axis; each independent lift axis, of the more than one lift axis, is communicably coupled to each other independent lift axis of the more than one lift axis of the common lift cell and forms a common output of the common lift cell that outputs the ordered sequence of mixed cases in accordance to the predetermined case out ordered sequence of mixed cases; the qualitative metric is a need time for the at least one case at a predetermined destination of the asynchronous level transport system of a corresponding level; the predetermined destination is a transfer station communicably coupling the asynchronous level transport system and a corresponding independent lift axis of the more than one independent lift axis; and the qualitative metric is a parametrized delay penalty metric describing effects in the asynchronous level transport from delays from a need time.

In accordance with the present disclosure, a method for product order fulfillment includes: providing a product order fulfillment system having: a multi-level transport system, each level thereof having a corresponding independent asynchronous level transport system, of mixed cases, separate and distinct from the asynchronous level transport system corresponding to each other level of the multi-level transport system, the asynchronous level transport system defining an array of asynchronous level transport axes, corresponding to the level, and being configured to hold and asynchronously transport at least one case providing transport of mixed cases along the array of asynchronous level transport axes, a lifting transport system with more than one independent lift axis, in a common lift cell, each of the more than one independent lift axis being configured to independently hold and transport the at least one case along a trajectory, independently of each other independent lift axis, so that the trajectory, of the lift, is asynchronous from each other respective trajectory of each other independent lift axis of the common lift cell effecting transport of mixed cases from the array of asynchronous level transport axes, and a controller operably coupled to the multi-level transport system and the lifting transport system, wherein the asynchronous trajectories of the common lift cell output an ordered sequence of mixed cases in accordance to a predetermined case out ordered sequence of mixed cases; and heuristically generating, with the controller, optimal trajectory solutions for the asynchronous trajectories, and assigning the at least one case to at least one asynchronous level transport axis based on at least one qualitative metric characterized by the optimal trajectory solutions.

In accordance with the present disclosure, the method includes one or more of: the more than one independent lift axis comprises a reciprocating axis; each independent lift axis, of the more than one lift axis, is communicably coupled to each other independent lift axis of the more than one lift axis of the common lift cell and forms a common output of the common lift cell, the method further comprising outputting, with the common output, the ordered sequence of mixed cases in accordance to the predetermined case out ordered sequence of mixed cases; the qualitative metric is a need time for the at least one case at a predetermined destination of the asynchronous level transport system of a corresponding level; the predetermined destination is a transfer station communicably coupling the asynchronous level transport system and a corresponding independent lift axis of the more than one independent lift axis; and the qualitative metric is a parametrized delay penalty metric describing effects in the asynchronous level transport from delays from a need time.

In accordance with the present disclosure, a method for product order fulfillment includes: providing a product order fulfillment system having: a multi-level transport system, each level thereof having a corresponding independent asynchronous level transport system, of mixed cases, separate and distinct from the asynchronous level transport system corresponding to each other level of the multi-level transport system, the asynchronous level transport system defining an array of asynchronous level transport axes, corresponding to the level, and being configured to hold and asynchronously transport at least one case providing transport of mixed cases along the array of asynchronous level transport axes, a lifting transport system with more than one independent lift axis, in a common lift cell, each of the more than one independent lift axis being configured to independently hold and transport the at least one case along a trajectory, independently of each other independent lift axis, so that the trajectory, of the lift, is asynchronous from each other respective trajectory of each other independent lift axis of the common lift cell effecting transport of mixed cases from the array of asynchronous level transport axes, and a controller operably coupled to the multi-level transport system and the lifting transport system, wherein the asynchronous trajectories of the common lift cell output an ordered sequence of mixed cases in accordance to a predetermined case out ordered sequence of mixed cases; and heuristically generating, with the controller, optimal trajectory solutions for the asynchronous trajectories, and tasking the at least one case to at least one asynchronous level transport axis characterized with at least one qualitative metric described by the optimal trajectory solution.

In accordance with the present disclosure, the method includes one or more of: the more than one independent lift axis comprises a reciprocating axis; each independent lift axis, of the more than one lift axis, is communicably coupled to each other independent lift axis of the more than one lift axis of the common lift cell and forms a common output of the common lift cell, the method further comprising outputting, with the common output, the ordered sequence of mixed cases in accordance to the predetermined case out ordered sequence of mixed cases; the qualitative metric is a need time for the at least one case at a predetermined destination of the asynchronous level transport system of a corresponding level; the predetermined destination is a transfer station communicably coupling the asynchronous level transport system and a corresponding independent lift axis of the more than one independent lift axis; and the qualitative metric is a parametrized delay penalty metric describing effects in the asynchronous level transport from delays from a need time.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the present disclosure.

What is claimed is:

1. A product order fulfillment system comprising:
a multi-level transport system, each level thereof having a corresponding independent asynchronous level transport system, of mixed cases, separate and distinct from the asynchronous level transport system corresponding to each other level of the multi-level transport system, the asynchronous level transport system defining an array of asynchronous level transport axes, corresponding to the level, and being configured to hold and asynchronously transport at least one case providing transport of mixed cases along the array of asynchronous level transport axes;
a lifting transport system with more than one independent lift axis, in a common lift cell, each of the more than one independent lift axis being configured to independently hold and transport the at least one case along a trajectory, independently of each other independent lift axis, so that the trajectory, of the lift, is asynchronous from each other respective trajectory of each other independent lift axis of the common lift cell effecting transport of mixed cases from the array of asynchronous level transport axes; and
a controller operably coupled to the multi-level transport system and the lifting transport system;
wherein the asynchronous trajectories of the common lift cell output an ordered sequence of mixed cases in accordance to a predetermined case out ordered sequence of mixed cases; and
wherein the controller is configured to heuristically generate optimal trajectory solutions for the asynchronous trajectories, and assign the at least one case to at least one asynchronous level transport axis based on at least one qualitative metric characterized by the optimal trajectory solutions.

2. The product order fulfillment system of claim 1, wherein the more than one independent lift axis comprises a reciprocating axis.

3. The product order fulfillment system of claim 1, wherein each independent lift axis, of the more than one lift axis, is communicably coupled to each other independent lift axis of the more than one lift axis of the common lift cell and forms a common output of the common lift cell that outputs the ordered sequence of mixed cases in accordance to the predetermined case out ordered sequence of mixed cases.

4. The product order fulfillment system of claim 1, wherein the qualitative metric is a need time for the at least one case at a predetermined destination of the asynchronous level transport system of a corresponding level.

5. The product order fulfillment system of claim 4, wherein the predetermined destination is a transfer station communicably coupling the asynchronous level transport system and a corresponding independent lift axis of the more than one independent lift axis.

6. The product order fulfillment system of claim 1, wherein the qualitative metric is a parametrized delay penalty metric describing effects in the asynchronous level transport from delays from a need time.

7. A product order fulfillment system comprising:
a multi-level transport system, each level thereof having a corresponding independent asynchronous level transport system, of mixed cases, separate and distinct from the asynchronous level transport system corresponding to each other level of the multi-level transport system, the asynchronous level transport system defining an array of asynchronous level transport axes, corresponding to the level, and being configured to hold and asynchronously transport at least one case providing transport of mixed cases along the array of asynchronous level transport axes;
a lifting transport system with more than one independent lift axis, in a common lift cell, each of the more than one independent lift axis being configured to independently hold and transport the at least one case along a trajectory, independently of each other independent lift axis, so that the trajectory, of the lift, is asynchronous from each other respective trajectory of each other independent lift axis of the common lift cell effecting transport of mixed cases from the array of asynchronous level transport axes; and
a controller operably coupled to the multi-level transport system and the lifting transport system;
wherein the asynchronous trajectories of the common lift cell output an ordered sequence of mixed cases in accordance to a predetermined case out ordered sequence of mixed cases; and
wherein the controller is configured to heuristically generate optimal (min time) trajectory solutions for the asynchronous trajectories, and task the at least one case to at least one asynchronous level transport axis characterized with at least one qualitative (qualification) metric described by the optimal trajectory solution.

8. The product order fulfillment system of claim 7, wherein the more than one independent lift axis comprises a reciprocating axis.

9. The product order fulfillment system of claim 7, wherein each independent lift axis, of the more than one lift axis, is communicably coupled to each other independent lift axis of the more than one lift axis of the common lift cell and forms a common output of the common lift cell that outputs the ordered sequence of mixed cases in accordance to the predetermined case out ordered sequence of mixed cases.

10. The product order fulfillment system of claim 7, wherein the qualitative metric is a need time for the at least one case at a predetermined destination of the asynchronous level transport system of a corresponding level.

11. The product order fulfillment system of claim 10, wherein the predetermined destination is a transfer station communicably coupling the asynchronous level transport system and a corresponding independent lift axis of the more than one independent lift axis.

12. The product order fulfillment system of claim 7, wherein the qualitative metric is a parametrized delay penalty metric describing effects in the asynchronous level transport from delays from a need time.

13. A method for product order fulfillment the method comprising:
providing a product order fulfillment system having:
a multi-level transport system, each level thereof having a corresponding independent asynchronous level transport system, of mixed cases, separate and distinct from the asynchronous level transport system corresponding to each other level of the multi-level transport system, the asynchronous level transport system defining an array of asynchronous level transport axes, corresponding to the level, and being configured to hold and asynchronously transport at least one case providing transport of mixed cases along the array of asynchronous level transport axes, a lifting transport system with more than one independent lift axis, in a common lift cell, each of the more than one independent lift axis being configured to independently hold and transport the at least one case along a trajectory, independently of each other independent lift axis, so that the trajectory, of the lift, is asynchronous from each other respective trajectory of each other independent lift axis of the common lift cell effecting transport of mixed cases from the array of asynchronous level transport axes, and
a controller operably coupled to the multi-level transport system and the lifting transport system,
wherein the asynchronous trajectories of the common lift cell output an ordered sequence of mixed cases in accordance to a predetermined case out ordered sequence of mixed cases; and
heuristically generating, with the controller, optimal trajectory solutions for the asynchronous trajectories, and assigning the at least one case to at least one asynchronous level transport axis based on at least one qualitative metric characterized by the optimal trajectory solutions.

14. The method of claim 13, wherein the more than one independent lift axis comprises a reciprocating axis.

15. The method of claim 13, wherein each independent lift axis, of the more than one lift axis, is communicably coupled to each other independent lift axis of the more than one lift axis of the common lift cell and forms a common output of the common lift cell, the method further comprising outputting, with the common output, the ordered sequence of mixed cases in accordance to the predetermined case out ordered sequence of mixed cases.

16. The method of claim 13, wherein the qualitative metric is a need time for the at least one case at a predetermined destination of the asynchronous level transport system of a corresponding level.

17. The method of claim 16, wherein the predetermined destination is a transfer station communicably coupling the asynchronous level transport system and a corresponding independent lift axis of the more than one independent lift axis.

18. The method of claim 13, wherein the qualitative metric is a parametrized delay penalty metric describing effects in the asynchronous level transport from delays from a need time.

19. A method for product order fulfillment, the method comprising:
providing a product order fulfillment system having:
a multi-level transport system, each level thereof having a corresponding independent asynchronous level transport system, of mixed cases, separate and distinct from the asynchronous level transport system corresponding to each other level of the multi-level transport system, the asynchronous level transport system defining an array of asynchronous level transport axes, corresponding to the level, and being configured to hold and asynchronously transport at least one case providing transport of mixed cases along the array of asynchronous level transport axes,
a lifting transport system with more than one independent lift axis, in a common lift cell, each of the more than one independent lift axis being configured to independently hold and transport the at least one case along a trajectory, independently of each other independent lift axis, so that the trajectory, of the lift, is asynchronous from each other respective trajectory of each other independent lift axis of the common lift cell effecting transport of mixed cases from the array of asynchronous level transport axes, and
a controller operably coupled to the multi-level transport system and the lifting transport system,
wherein the asynchronous trajectories of the common lift cell output an ordered sequence of mixed cases in accordance to a predetermined case out ordered sequence of mixed cases; and
heuristically generating, with the controller, optimal trajectory solutions for the asynchronous trajectories, and tasking the at least one case to at least one asynchronous level transport axis characterized with at least one qualitative metric described by the optimal trajectory solution.

20. The method of claim 19, wherein the more than one independent lift axis comprises a reciprocating axis.

21. The method of claim 19, wherein each independent lift axis, of the more than one lift axis, is communicably coupled to each other independent lift axis of the more than one lift axis of the common lift cell and forms a common output of the common lift cell, the method further comprising outputting, with the common output, the ordered sequence of mixed cases in accordance to the predetermined case out ordered sequence of mixed cases.

22. The method of claim 19, wherein the qualitative metric is a need time for the at least one case at a predetermined destination of the asynchronous level transport system of a corresponding level.

23. The method of claim 22, wherein the predetermined destination is a transfer station communicably coupling the asynchronous level transport system and a corresponding independent lift axis of the more than one independent lift axis.

24. The method of claim 19, wherein the qualitative metric is a parametrized delay penalty metric describing effects in the asynchronous level transport from delays from a need time.
